(19) United States
(12) Patent Application Publication
(10) Pub. No.: US 2026/0197052 A1
(43) Pub. Date: Jul. 9, 2026

(54) POWER OFFSET VALUES FOR COHERENT JOINT TRANSMISSION MULTI-TRANSMISSION RECEPTION POINT COMMUNICATIONS

(71) Applicant: QUALCOMM Incorporated, San Diego, CA (US)

(72) Inventors: Jing DAI, Beijing (CN); Lei XIAO, San Jose, CA (US); Mostafa KHOSHNEVISAN, San Diego, CA (US); Peter GAAL, San Diego, CA (US); Faris RASSAM, El Cajon, CA (US); Jae Ho RYU, San Diego, CA (US)

(21) Appl. No.: 19/128,122

(22) PCT Filed: Jan. 4, 2023
(86) PCT No.: PCT/CN2023/070323

§ 371 Date: May 7, 2025

(51) Int. Cl. H04B 7/06; H04B 17/318

(52) U.S. Cl. CPC H04B 7/0626; H04B 17/318

(57) ABSTRACT

Methods, systems, and devices for wireless communications are described. A user equipment (UE) may receive control messaging that indicates one or more configurations for reference signal resources. In one example, the control message may indicate a configuration for a set of two or more reference signals, where the configuration includes a power offset value for the set of two or more reference signals. In another example, the control message may indicate respective configurations for one or more reference signal resources, where each configuration indicates a respective threshold power offset for each reference signal resource. The UE may receive the reference signals based on the configuration, measure each reference signal, and generate a channel quality indicator (CQI) based on the power offset values received in the configurations and the measurements of the reference signals. Based on generating the CQI, the UE may transmit a channel state information report indicating the CQI.

### CROSS REFERENCE

The present application for patent is a 371 national phase filing of International Patent Application No. PCT/CN2023/070323 by DAI et al., entitled “POWER OFFSET VALUES FOR COHERENT JOINT TRANSMISSION MULTI-TRANSMISSION RECEPTION POINT COMMUNICATIONS,” filed Jan. 4, 2023, assigned to the assignee hereof, and expressly incorporated by reference herein.

### FIELD OF TECHNOLOGY

The following relates to wireless communications, including power offset values for coherent joint transmission (CJT) multi-transmission reception point communications (mTRP).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, a UE may transmit channel state information reports to the network entity based on channel measurements on one or more reference signals.

### SUMMARY

The described techniques relate to improved methods, systems, devices, and apparatuses that support power offset values for coherent joint transmission (CJT) multi-transmission reception point (mTRP) communications. For example, the described techniques provide for a network entity to communicate improved power offset values to a user equipment (UE) in CJT mTRP systems. As a result of the power offset values signaled by the network entity, a UE may efficiently determine power values for downlink transmissions in CJT mTRP systems. In particular, when the UE assumes a downlink power (e.g., a physical downlink shared channel (PDSCH) power) for mTRPs when deriving channel state information (CSI) feedback, the UE may base the assumption on a power offset value for a set of two or more reference signal resources (e.g., a CSI reference signal (CSI-RS) resource set) or a threshold (e.g., maximum) power offset value for respective CSI-RS resources that are associated with different transmission reception points (TRPs). In one example, the UE may receive a control message indicating a set of two or more reference signal resources, where the control message indicates a power offset value for the set of two or more reference signals. In such examples, the UE may receive one or more reference signals based on the configuration, measure each reference signal, and calculate a downlink shared channel power associated with each reference signal based on the power offset value associated with the set of two or more reference signals and the measurements of each reference. The UE may generate a channel quality indicator (CQI) based on the calculated powers and transmit the CQI in a CSI report to the network.

In another example, the UE may receive a control message indicating one or more reference signal resource configurations, where each reference signal resource is associated with a threshold (e.g., maximum) power offset value. The UE may receive one or more reference signals, measure each reference signal, and calculate a downlink shared channel power of a first reference signal based on the threshold power offset value associated with a first reference signal resource and the measurements of the first reference signal, where the first reference signal has a measured power that meets a threshold (e.g., it is the strongest measured power). Based on calculating the downlink shared channel power of the first reference signal, the UE may calculate a downlink power associated with a second reference signal using the threshold power offset value associated with the first reference signal, a scaling power offset value, and the measurements of the first reference signal and measurements of the second reference signal. The UE may generate a CQI based on the calculated downlink shared channel powers and transmit a CSI report that includes the CQI to the network entity.

A method for wireless communication at a UE is described. The method may include receiving a control message indicating a configuration for a set of two or more reference signal resources, the configuration including a power offset value for the set of two or more reference signal resources, receiving one or more reference signals based on the configuration of the set of two or more reference signal resources, where each reference signal of the one or more reference signals is associated with a respective TRP, generating a CQI based on the power offset value for the set of two or more reference signal resources and one or more measurements of each reference signal of the one or more reference signals, and transmitting a CSI report including the CQI.

An apparatus for wireless communication at a UE is described. The apparatus may include a processor, memory coupled with the processor, and instructions stored in the memory. The instructions may be executable by the processor to cause the apparatus to receive a control message indicating a configuration for a set of two or more reference signal resources, the configuration including a power offset value for the set of two or more reference signal resources, receive one or more reference signals based on the configuration of the set of two or more reference signal resources, where each reference signal of the one or more reference signals is associated with a respective TRP, generate a CQI based on the power offset value for the set of two or more reference signal resources and one or more measurements of each reference signal of the one or more reference signals, and transmit a CSI report including the CQI.

Another apparatus for wireless communication at a UE is described. The apparatus may include means for receiving a control message indicating a configuration for a set of two or more reference signal resources, the configuration including a power offset value for the set of two or more reference signal resources, means for receiving one or more reference signals based on the configuration of the set of two or more reference signal resources, where each reference signal of the one or more reference signals is associated with a respective TRP, means for generating a CQI based on the power offset value for the set of two or more reference signal resources and one or more measurements of each reference signal of the one or more reference signals, and means for transmitting a CSI report including the CQI.

A non-transitory computer-readable medium storing code for wireless communication at a UE is described. The code may include instructions executable by a processor to receive a control message indicating a configuration for a set of two or more reference signal resources, the configuration including a power offset value for the set of two or more reference signal resources, receive one or more reference signals based on the configuration of the set of two or more reference signal resources, where each reference signal of the one or more reference signals is associated with a respective TRP, generate a CQI based on the power offset value for the set of two or more reference signal resources and one or more measurements of each reference signal of the one or more reference signals, and transmit a CSI report including the CQI.

In some examples of the method, apparatuses, and non-transitory computer-readable medium described herein, generating the CQI may include operations, features, means, or instructions for calculating a power associated with a downlink channel for each reference signal of the one or more reference signals based on the power offset value for the set of two or more reference signal resources and the one or more measurements, where the CQI may be based on the power of the downlink channel for each reference signal of the one or more reference signals.

In some examples of the method, apparatuses, and non-transitory computer-readable medium described herein, generating the CQI may include operations, features, means, or instructions for calculating a power associated with a downlink channel for each reference signal of the one or more reference signals based on the power offset value for the set of two or more reference signal resources, the one or more measurements, and a scaled power of the set of two or more reference signal resources, where the scaled power may be based on a quantity of UE-selected TRPs from a total quantity of TRPs.

In some examples of the method, apparatuses, and non-transitory computer-readable medium described herein, receiving the control message indicating the configuration may include operations, features, means, or instructions for receiving the control message indicating a respective power offset value for each reference signal resource of the set of two or more reference signal resources, where the power offset value for each reference signal resource of the set of two or more reference signal resources may be equal based on the set of two or more reference signal resources being associated with a CJT by mTRPs.

In some examples of the method, apparatuses, and non-transitory computer-readable medium described herein, each reference signal of the one or more reference signals may be transmitted at an equal power based on the power offset value for the set of two or more reference signal resources.

In some examples of the method, apparatuses, and non-transitory computer-readable medium described herein, the set of two or more reference signal resources includes a CSI-RS resource set.

In some examples of the method, apparatuses, and non-transitory computer-readable medium described herein, the control message includes a radio resource control (RRC) message.

A method for wireless communication at a UE is described. The method may include receiving a control message indicating respective configurations for one or more reference signal resources, the respective configurations including respective threshold power offset values for each reference signal resource of the one or more reference signal resources, receiving one or more reference signals based on the respective configurations, where each reference signal of the one or more reference signals is associated with a respective TRP, generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource, and transmitting a CSI report including the CQI.

An apparatus for wireless communication at a UE is described. The apparatus may include a processor, memory coupled with the processor, and instructions stored in the memory. The instructions may be executable by the processor to cause the apparatus to receive a control message indicating respective configurations for one or more reference signal resources, the respective configurations including respective threshold power offset values for each reference signal resource of the one or more reference signal resources, receive one or more reference signals based on the respective configurations, where each reference signal of the one or more reference signals is associated with a respective TRP, generate a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource, and transmit a CSI report including the CQI.

Another apparatus for wireless communication at a UE is described. The apparatus may include means for receiving a control message indicating respective configurations for one or more reference signal resources, the respective configurations including respective threshold power offset values for each reference signal resource of the one or more reference signal resources, means for receiving one or more reference signals based on the respective configurations, where each reference signal of the one or more reference signals is associated with a respective TRP, means for generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource, and means for transmitting a CSI report including the CQI.

A non-transitory computer-readable medium storing code for wireless communication at a UE is described. The code may include instructions executable by a processor to receive a control message indicating respective configurations for one or more reference signal resources, the respective configurations including respective threshold power offset values for each reference signal resource of the one or more reference signal resources, receive one or more reference signals based on the respective configurations, where each reference signal of the one or more reference signals is associated with a respective TRP, generate a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource, and transmit a CSI report including the CQI.

In some examples of the method, apparatuses, and non-transitory computer-readable medium described herein, generating the CQI may include operations, features, means, or instructions for calculating a power associated with a downlink channel of the first reference signal based on the threshold power offset value associated with the first reference signal resource and one or more measurements of the first reference signal.

In some examples of the method, apparatuses, and non-transitory computer-readable medium described herein, generating the CQI may include operations, features, means, or instructions for calculating a power associated with a downlink channel associated with a second reference signal based on the power offset value associated with the first reference signal resource, a scaling power parameter associated with the second reference signal, and one or more measurements of the first reference signal and of the second reference signal.

Some examples of the method, apparatuses, and non-transitory computer-readable medium described herein may further include operations, features, means, or instructions for calculating one or more power coefficients of the first reference signal based on a squared summation of measured amplitudes across the first reference signal and calculating one or more power coefficients of a second reference signal based on a squared summation of measured amplitudes across the second reference signal.

In some examples of the method, apparatuses, and non-transitory computer-readable medium described herein, the scaling power parameter may be the one or more power coefficients of the second reference signal divided by the one or more power coefficients of the first reference signal.

Some examples of the method, apparatuses, and non-transitory computer-readable medium described herein may further include operations, features, means, or instructions for determining an estimated channel measurement for a channel between the UE and a first TRP associated with the first reference signal, where the estimated channel measurement may be based on the threshold power offset value associated with the first reference signal resource and calculating a precoding matrix indicator (PMI) based on the estimated channel measurement.

Some examples of the method, apparatuses, and non-transitory computer-readable medium described herein may further include operations, features, means, or instructions for determining an estimated channel measurement for a channel between the UE and a second TRP different from a first TRP associated with the first reference signal, the second TRP being associated with a reference signal from the subset of the one or more reference signals, where the estimated channel measurement may be based on the threshold power offset value associated with the first reference signal resource and the scaling power parameter and calculating a PMI based on the estimated channel measurement.

In some examples of the method, apparatuses, and non-transitory computer-readable medium described herein, the one or more reference signal resources includes CSI-RS resources.

In some examples of the method, apparatuses, and non-transitory computer-readable medium described herein, the control message includes a RRC message.

A method for wireless communication at a network entity is described. The method may include transmitting a control message indicating a configuration for a set of two or more reference signal resources, the configuration including a power offset value for the set of two or more reference signal resources, transmitting one or more reference signals based on the configuration of the set of two or more reference signal resources, where each reference signal of the one or more reference signals is associated with a respective TRP at the network entity, and receiving a CSI report including a CQI, where the CQI is based on the power offset value for the set of two or more reference signal resources and one or more measurements of each reference signal of the one or more reference signals.

An apparatus for wireless communication at a network entity is described. The apparatus may include a processor, memory coupled with the processor, and instructions stored in the memory. The instructions may be executable by the processor to cause the apparatus to transmit a control message indicating a configuration for a set of two or more reference signal resources, the configuration including a power offset value for the set of two or more reference signal resources, transmit one or more reference signals based on the configuration of the set of two or more reference signal resources, where each reference signal of the one or more reference signals is associated with a respective TRP at the network entity, and receive a CSI report including a CQI, where the CQI is based on the power offset value for the set of two or more reference signal resources and one or more measurements of each reference signal of the one or more reference signals.

Another apparatus for wireless communication at a network entity is described. The apparatus may include means for transmitting a control message indicating a configuration for a set of two or more reference signal resources, the configuration including a power offset value for the set of two or more reference signal resources, means for transmitting one or more reference signals based on the configuration of the set of two or more reference signal resources, where each reference signal of the one or more reference signals is associated with a respective TRP at the network entity, and means for receiving a CSI report including a CQI, where the CQI is based on the power offset value for the set of two or more reference signal resources and one or more measurements of each reference signal of the one or more reference signals.

A non-transitory computer-readable medium storing code for wireless communication at a network entity is described. The code may include instructions executable by a processor to transmit a control message indicating a configuration for a set of two or more reference signal resources, the configuration including a power offset value for the set of two or more reference signal resources, transmit one or more reference signals based on the configuration of the set of two or more reference signal resources, where each reference signal of the one or more reference signals is associated with a respective TRP at the network entity, and receive a CSI report including a CQI, where the CQI is based on the power offset value for the set of two or more reference signal resources and one or more measurements of each reference signal of the one or more reference signals.

In some examples of the method, apparatuses, and non-transitory computer-readable medium described herein, transmitting the control message indicating the configuration may include operations, features, means, or instructions for transmitting the control message indicating a respective power offset value for each reference signal resource of the set of two or more reference signal resources, where the power offset value for each reference signal resource of the set of two or more reference signal resources may be equal based on the set of two or more reference signal resources being associated with a CJT by mTRPs.

In some examples of the method, apparatuses, and non-transitory computer-readable medium described herein, each reference signal of the one or more reference signals may be transmitted at an equal power based on the power offset value of the set of two or more reference signal resources.

Some examples of the method, apparatuses, and non-transitory computer-readable medium described herein may further include operations, features, means, or instructions for transmitting one or more downlink messages associated with the one or more reference signals, the one or more downlink messages being associated with a CJT downlink scheme, where a power associated with each of the one or more downlink messages may be based on the CSI report.

In some examples of the method, apparatuses, and non-transitory computer-readable medium described herein, the set of two or more reference signal resources includes a CSI-RS resource set.

In some examples of the method, apparatuses, and non-transitory computer-readable medium described herein, the control message includes a RRC message.

A method for wireless communication at a network entity is described. The method may include transmitting a control message indicating respective configurations for one or more reference signal resources, the respective configurations including respective threshold power offset values for each reference signal resource of the one or more reference signal resources, transmitting one or more reference signals based on the respective configurations, where each reference signal of the one or more reference signals is associated with a respective TRP, and receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

An apparatus for wireless communication at a network entity is described. The apparatus may include a processor, memory coupled with the processor, and instructions stored in the memory. The instructions may be executable by the processor to cause the apparatus to transmit a control message indicating respective configurations for one or more reference signal resources, the respective configurations including respective threshold power offset values for each reference signal resource of the one or more reference signal resources, transmit one or more reference signals based on the respective configurations, where each reference signal of the one or more reference signals is associated with a respective TRP, and receive a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

Another apparatus for wireless communication at a network entity is described. The apparatus may include means for transmitting a control message indicating respective configurations for one or more reference signal resources, the respective configurations including respective threshold power offset values for each reference signal resource of the one or more reference signal resources, means for transmitting one or more reference signals based on the respective configurations, where each reference signal of the one or more reference signals is associated with a respective TRP, and means for receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

A non-transitory computer-readable medium storing code for wireless communication at a network entity is described. The code may include instructions executable by a processor to transmit a control message indicating respective configurations for one or more reference signal resources, the respective configurations including respective threshold power offset values for each reference signal resource of the one or more reference signal resources, transmit one or more reference signals based on the respective configurations, where each reference signal of the one or more reference signals is associated with a respective TRP, and receive a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

Some examples of the method, apparatuses, and non-transitory computer-readable medium described herein may further include operations, features, means, or instructions for transmitting one or more downlink messages associated with the one or more reference signals, the one or more downlink messages being associated with a CJT downlink scheme, where a power associated with each of the one or more downlink messages may be based on the CSI report.

In some examples of the method, apparatuses, and non-transitory computer-readable medium described herein, the one or more reference signal resources includes a CSI-RS resource set.

In some examples of the method, apparatuses, and non-transitory computer-readable medium described herein, the control message includes a RRC message.

### BRIEF DESCRIPTION OF THE DRAWINGS

FIG. 1 illustrates an example of a wireless communications system that supports power offset values for coherent joint transmission (CJT) multi-transmission reception point (mTRP) communications in accordance with one or more aspects of the present disclosure.

FIG. 2 illustrates an example of a wireless communications system that supports power offset values for CJT mTRP communications in accordance with one or more aspects of the present disclosure.

FIG. 3A and FIG. 3B illustrate examples of power allocation diagrams that support power offset values for CJT mTRP communications in accordance with one or more aspects of the present disclosure.

FIGS. 4 and 5 illustrate examples of process flows that support power offset values for CJT mTRP communications in accordance with one or more aspects of the present disclosure.

FIGS. 6 and 7 illustrate block diagrams of devices that support power offset values for CJT mTRP communications in accordance with one or more aspects of the present disclosure.

FIG. 8 illustrates a block diagram of a communications manager that supports power offset values for CJT mTRP communications in accordance with one or more aspects of the present disclosure.

FIG. 9 illustrates a diagram of a system including a device that supports power offset values for CJT mTRP communications in accordance with one or more aspects of the present disclosure.

FIGS. 10 and 11 illustrate block diagrams of devices that support power offset values for CJT mTRP communications in accordance with one or more aspects of the present disclosure.

FIG. 12 illustrates a block diagram of a communications manager that supports power offset values for CJT mTRP communications in accordance with one or more aspects of the present disclosure.

FIG. 13 illustrates a diagram of a system including a device that supports power offset values for CJT mTRP communications in accordance with one or more aspects of the present disclosure.

FIGS. 14 through 21 illustrate flowcharts showing methods that support power offset values for CJT mTRP communications in accordance with one or more aspects of the present disclosure.

### DETAILED DESCRIPTION

In some wireless communications systems, a network may communicate with a user equipment (UE) via one or more transmission reception points (TRPs) using a coherent joint transmission (CJT) scheme. To facilitate communications between the UE and the multiple TRPs, a network entity may transmit channel state information (CSI) reference signals (CSI-RSs) to the UE, where each CSI-RS may be associated with a respective TRP. Based on receiving the CSI-RSs, the UE may estimate a downlink shared channel (e.g., physical downlink shared channel (PDSCH)) power associated with each CSI-RS for the calculation of CSI feedback (e.g., a channel quality indicator (CQI) included in a CSI report). In such cases, the power of the downlink shared channel may be assumed (e.g., calculated) by the UE based on a configured power offset value (e.g., a ratio between a PDSCH power metric and a CSI-RS power metric) associated with each CSI-RS.

For example, in order for the UE to estimate the downlink shared channel powers, the network entity may configure each CSI-RS with a respective pre-fixed power offset value, such that the UE may receive each CSI-RS, perform channel measurements of each CSI-RS, and estimate a corresponding downlink shared channel power based on the respective power offset values and channel measurements. The UE may report the estimated downlink shared channel power to the network entity (which may be taken into consideration by the network for downlink CJT transmissions). However, using the pre-fixed power offset values when calculating the downlink shared channel power may add restrictions in the computation of the CQI (e.g., based on restrictions placed on precoding matrices associated with different TRPs). As such, the pre-fixed power offset values configured for the respective CSI-RSs, each associated with different TRPs, may result in inaccuracies when the UE generates the CQI (e.g., based on a precoding matrix indicator (PMI)) that is reported back to the network, thereby reducing performance in the communications system.

The techniques described herein may enable the network entity to configure a power offset value for a set of CSI-RSs when communicating in accordance with CJT multiple-transmission reception point (mTRP) techniques. For example, the UE may receive control messaging indicating a configuration for a set of CSI-RSs and a power offset value for the set of CSI-RSs (e.g., to use in calculating a downlink shared channel powers associated with each CSI-RS). The UE may receive the CSI-RSs from respective TRPs based on the configuration and measure each received CSI-RS. Based on measuring the CSI-RSs, the UE may calculate the downlink shared channel power associated with each CSI-RS based on the power offset value for the set of CSI-RSs and the one or more measurements of each CSI-RS. In this way, the network entity may ensure that each TRP transmits the respective CSI-RSs at an approximately equal power, without adding a restriction to the channel measurements.

In some other examples, the techniques described herein may enable the network entity to configure a threshold (e.g., maximum) power offset value for each CSI-RS, such that the UE may use the threshold power offset value associated with the strongest measured CSI-RS (e.g., associated with the strongest TRP) when determining the downlink shared channel power of the strongest measured CSI-RS. To calculate the downlink shared channel powers of other CSI-RSs (e.g., associated with other TRPs), the UE may use a scaling power parameter (e.g., a parameter that scales a power value, a parameter that modifies a power value) and channel measurements associated with the strongest measured CSI-RS.

For example, the network entity may transmit control signaling indicating one or more CSI-RS resources and a respective threshold power offset for each CSI-RS resource. Based on the configuration, the UE may receive each CSI-RS and perform channel measurements using each CSI-RS. The UE may calculate a downlink shared channel power for a first CSI-RS using the threshold power offset associated with the first CSI-RS based on the first CSI-RS having the strongest measured power (e.g., relative to the measured powers of the other CSI-RSs). The UE may calculate a downlink shared channel power for a second CSI-RS using the scaling power parameter, the power offset value associated with the first CSI-RS, and measurements of the first and second reference signals. In this way, the UE may calculate the downlink shared channel power of each CSI-RS (of each TRP) with increased accuracy and without adding a restriction to the channel measurements, thereby enabling enhanced CQI determination for the UE, such as in cases of CJT mTRP communications.

Aspects of the disclosure are initially described in the context of wireless communications systems. Aspects of the disclosure are further described in the context of power allocation diagrams and process flows. Aspects of the disclosure are further illustrated by and described with reference to apparatus diagrams, system diagrams, and flowcharts that relate to power offset values for CJT mTRP communications.

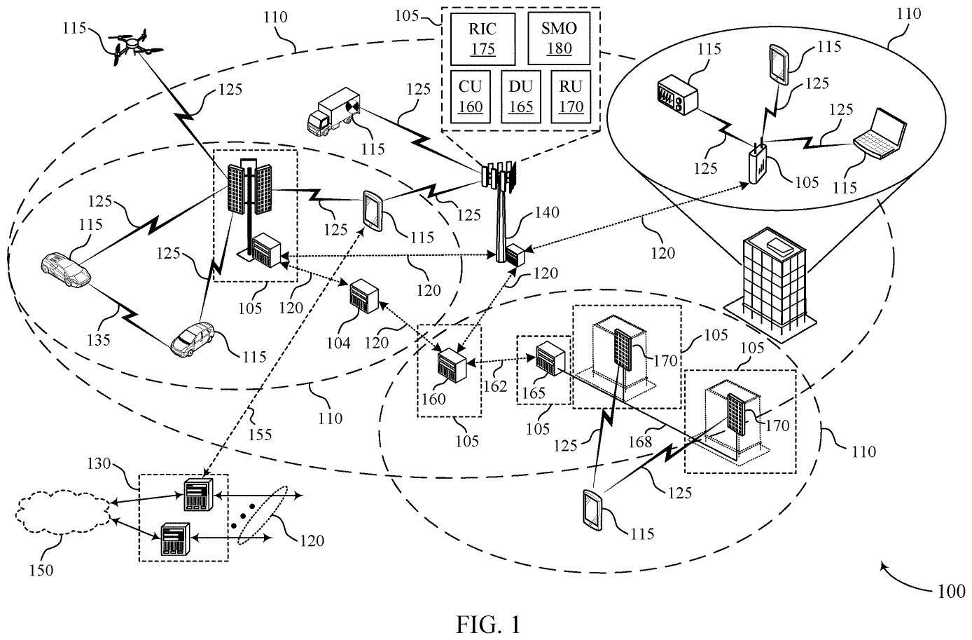

FIG. 1 illustrates an example of a wireless communications system 100 that supports power offset values for CJT mTRP communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support power offset values for CJT mTRP communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some examples of the wireless communications system 100 may include enhancements for CSI acquisition in CJTs using frequency range one (FR1) (e.g., a frequency range in NR spanning 410 MHz to 7,125 MHz) and up to four TRPs, in scenarios where there may be sufficient (e.g., ideal) backhaul and synchronization in addition to the ability to use the same quantity of antenna ports across TRPs (which may be associated with the same or different network entities 105). For example, the network entity 105 may use type 2 codebook refinement for CJT mTRP communications that targets frequency division duplexing (FDD) and associated CSI reporting by considering a throughput-overhead trade-off. In such examples, a network entity 105 may use up to a threshold quantity of CSI-RS ports per resource (e.g., up to 32 CSI-RS ports). To support such enhancements to CJT type 2 CSI reporting, the network entity 105 my utilize a relatively larger quantity of ports (e.g., up to 32 CSI-RS ports) for CJT in low-frequency bands, with distributed TRPs and panels in favor of using a single-TRP or panel with 32 ports (which, in some cases, may result in an antenna array size being relatively too large for practical deployment).

Using current techniques, a UE 115 may receive a CSI-RS via a single TRP for type 2 CSI reporting. As such, the UE 115 may calculate a precoder (e.g., W, a matrix that supports up to rank 4). For example, the precoder (e.g., W) may be calculated across a quantity of N₃ subbands (e.g., PMI subbands) and be a Nₜ×N₃ matrix represented as:

$$W = {W}_{1} \times {\tilde{W}}_{2} \times {W}_{f}^{H} . {W}_{1}$$

may be a spatial domain (SD) basis (e.g., a DFT basis) which is an Nₜ×2L matrix and represents a common layer of transmission. Nₜ may be an RRC-configured parameter and represent a quantity of transmission antennas with O₁ and O₂ oversampling (e.g., Nₜ=2N₁O₁N₂O₂). L may be an RRC-configured parameter and represent a quantity of beams (e.g., 2, 4, or 6 beams at the network entity 105).

$${W}_{f}^{H}$$

may be a frequency domain (PD) basis (e.g., DFT basis) and be represented as an M×N₃ matrix, where

$${W}_{f}^{H}$$

is specific to a transmission layer. M may be a quantity of FD basis and be rank-pair specific (e.g., M₁=M₂ for rank 1 or 2 and M₃=M₄ for rank 3 and 4, where either M₁ or M₃ are RRC configured). \tilde{W}₂ may represent coefficients of CSI-RS measurements and be represented by a 2L×M matrix and be for a specific transmission layer. For reach layer, the UE 115 may report up to K₀ non-zero coefficients, where K₀ may be RRC configured. Across all layers, the UE 115 may report up to 2K₀ non-zero coefficients, where unreported coefficients may be set to zeros. Further, the UE 115 may quantize the coefficients represented by \tilde{W}₂.

For example, the UE 115 may quantize the non-zero coefficients of \tilde{W}₂ via layer-independent quantization (e.g., quantize each \tilde{W}₂ associated with a respective layer). The non-zero coefficients may be equal to 1, 0, or in the form of p_{ref}p_{0,0}e^{j φ}^{_{0,0}}. In such examples, the UE 115 may report the index for the strongest coefficients, where UE 115 may refrain from quantizing the strongest coefficients of \tilde{W}₂ due to the values of such coefficients being equal to one. Such coefficients may be used as a reference for stronger polarization. Based on reporting the index for strongest coefficients, the UE 115 may quantize reference power (e.g., p_{ref}) for relatively weaker polarized coefficients (e.g., weaker relative to the coefficients equal to 1) via four bits, where the four bits represent values starting from 0 dB with steps of −1.5 dB (e.g., power steps of −1.5 dB). The UE 115 may then quantize the differential amplitude (e.g., p_{0,0}) of each entry in \tilde{W}₂ via three bits, where the three bits represent a value from 0 dB with 3 dB steps. Based on quantizing the differential amplitudes, the UE 115 may quantize the phase (e.g., e^{jφ}^{_{0,0}}) of each entry in \tilde{W}₂, for example, using a phase-shift keying (PSK) alphabet (e.g., a 16PSK alphabet, which may be relatively more expansive then an 8PSK alphabet).

For CJT mTRP communications, the UE 115 may calculate one or more precoders associated with a respective TRP based on one or more codebooks associated with one or more modes of operations. In a first mode of operation (e.g., Mode 1 Codebook), the UE 115 may receive transmissions from multiple TRPs that are co-located at a single network entity 105 (e.g., intra-site communications). In some cases, the TRPs (e.g., and associated antenna panels) may have the same orientation. Alternatively, the TRPs (e.g., and associated antenna panels) may have different orientations (e.g., inter-sector orientations). In the first mode of operation (e.g., FD-independent), the UE 115 may receive one or more CSI-RSs from respective TRPs and calculate the precoder according to the codebook structure outlined in equation 1:

$$[ \begin{matrix}{W}^{TRP \#A} \\ {W}^{TRP \#B}\end{matrix} ] = [ \begin{matrix}{W}_{1 , A} \times {\tilde{W}}_{2 , A} \times {W}_{f , A}^{H} \\ {W}_{1 , B} \times {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & {\tilde{W}}_{2 , B}\end{matrix} ] \times [ \begin{matrix}{W}_{f , A}^{H} \\ {W}_{f , B}^{H}\end{matrix} ] \qquad ( 1 )$$

In the second mode of operation (e.g., Mode 2 Codebook), the UE 115 may receive transmissions from distributed TRPs (e.g., TRPs located at different network entities or inter-site communications). As such, in the second mode of operation (e.g., FD-Joint), the UE 115 may receive one or more CSI-RSs and calculate the precoders according to a codebook structure outlined in equation 2:

$$[ \begin{matrix}{W}^{TRP \#A} \\ {W}^{TRP \#B}\end{matrix} ] = [ \begin{matrix}{W}_{1 , A} \times {\tilde{W}}_{2 , A} \times {W}_{f}^{H} \\ {W}_{1 , B} \times {\tilde{W}}_{2 , B} \times {W}_{f}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} \\ {\tilde{W}}_{2 , B}\end{matrix} ] \times {W}_{f}^{H} \qquad ( 2 )$$

By using two modes, the UE 115 may share commonality in detailed designs such as parameter combinations, basis selection, TRP (group) selection, reference amplitude, and W2 quantization schemes between multiple TRPs.

In some cases, the UE 115 may calculate a CQI as part of CSI measurement reporting, where the CQI may be based on the precoder (e.g., PMI). As such, in a single TRP communication system, the UE 115 may receive a configuration for a CSI-RS resource (e.g., such as a non-zero power (NZP) CSI-RS resource) that includes a power offset value (e.g., powerControlOffset, a PDSCH-to-CSI-RS energy per resource element (EPRE) ratio, which may be referred to herein as a Pc ratio) that ranges in value between −8 to −15 dB with a 1 dB step. As such, if the UE 115 receives multiple CSI-RSs, each CSI-RS resource associated with multiple CSI-RSs may be configured with a respective power offset. The power offset value (e.g., Pc ratio) may represent

$$10 {log}_{10} \frac{{P}_{PDSCH}}{{P}_{CSIRS}} ,$$

where P_{PDSCH} is the downlink shared channel power associated with the CSI-RS and P_{CSIRS} is the channel measurements of the CSI-RS. Both the P_{PDSCH} and P_{CSIRS} may be the per resource element energy in a linear domain. The CSI-RS resource configuration may contain one or more parameters to enable the UE to receive the respective CSI-RSs. The one or more parameters may be a resource identification (ID) (e.g., nzp-CSI-RS-ResoruceID), a resource mapping parameter (e.g., resoruceMapping), the power control offset, a power control offset value step value (e.g., powerCotnrolOffsetSS), a scrambling ID (e.g., scramblingID), a periodicity and offset parameter (e.g., periodicity AndOffset), and quasi-colocation (QCL) information (e.g., qcl-InforPeriodicCSI-RS).

In a single TRP scheme, the UE 115 may assume (e.g., estimate or calculate) the corresponding downlink shared channel (e.g., PDSCH) power based on the received power offset value and generate the CQI. As an illustrative example, the UE 115 may receive a CSI-RS configuration indicating time and frequency resources for a CSI-RS and a power offset value associated with the CSI-RS, where the power offset value is configured to be −3 dB (e.g., or any other negative value). Thus, the UE 115 may calculate (e.g., assume) that the downlink shared channel power may be transmitted at half the power of the measured CSI-RS. In such examples, the network entity 105 may transmit the CSI-RS with power boosting and with a frequency-comb pattern.

As another illustrative example, the UE 115 may receive a CSI-RS resource configuration from a single TRP, where the power offset value may be configured as 6 dB (e.g., or any other positive value). Thus, the UE 115 may calculate that the downlink shared channel power may be transmitted at four times the power of the measured CSI-RS. In such examples, the network entity 105 may, at the time of scheduling the corresponding downlink shared channel, not use the full bandwidth for downlink transmissions in order for the downlink shared channel to be allocated with a higher per resource element power or energy (e.g., according to the calculated power). In some cases, the network entity 105 may not follow the power offset value (e.g., calculated downlink shared channel power indicated from the UE 115 via the CQI in the CSI report) when scheduling the downlink shared channel. In such cases, the network entity 105 may use (e.g., use in allocating downlink shared channel power) the power offset value as an assumption for the UE reported CQI.

In order for the UE 115 to estimate the downlink shared channel powers of multiple CSI-RSs transmitted via multiple TRPs, the network entity 105 may configure each CSI-RS with a respective pre-fixed power offset value, such that the UE 115 may receive each CSI-RS, perform channel measurements of each CSI-RS, and estimate a corresponding downlink shared channel power based on the respective power offset values and channel measurements. The UE 115 may report the estimated downlink shared channel power to the network entity 105 (which may be taken into consideration by the network for downlink CJT transmissions). However, using the pre-fixed power offset values when calculating the downlink shared channel power of CJT mTRP communications may add restrictions in the computation of the CQI (e.g., based on restrictions placed on precoding matrices associated with different TRPs). As such, the pre-fixed power offset values configured for the respective CSI-RSs, each associated with different TRPs, may result in inaccuracies when the UE 115 generates the CQI (e.g., based on a PMI) that is reported back to the network, thereby reducing performance in the communications system.

In some examples, the techniques described herein may enable the network entity 105 to configure a power offset value for a set of two or more CSI-RSs (e.g., a same power offset value for an NZP CSI-RS resource set). For example, the UE 115 may receive control messaging indicating a configuration for a set of CSI-RSs and a power offset value for the set of CSI-RSs (e.g., to use in calculating a downlink shared channel powers associated with each CSI-RS). The UE 115 may receive the CSI-RSs of the set of two or more CSI-RSs from respective TRPs based on the configuration and measure each received CSI-RS. Based on measuring the CSI-RSs, the UE 115 may calculate the downlink shared channel power associated with each CSI-RS based on the power offset value for the set of CSI-RSs and the one or more measurements of each CSI-RS. In this way, the power offset for the set of CSI-RSs may ensure that each TRP transmits the respective CSI-RSs at an equal power, without adding a restriction to the channel measurements.

In some other examples, the techniques described herein may enable the network entity 105 to configure a threshold (e.g., maximum) power offset value for each CSI-RS, such that the UE 115 may use the threshold power offset value to determine the downlink power associated with the strongest measured CSI-RS (e.g., associated with the strongest TRP). To calculate the downlink shared channel powers of other CSI-RSs (e.g., associated with other TRPs), the UE 115 may use a scaling power value and channel measurements associated with the strongest measured CSI-RS. For example, the network entity 105 may transmit control signaling indicating one or more CSI-RS resources and a respective threshold power offset for each CSI-RS resource. Based on the configuration, the UE 115 may receive each CSI-RS and perform channel measurements using each CSI-RS. The UE 115 may calculate a downlink shared channel power for a first CSI-RS using the threshold power offset associated with the first CSI-RS based on the first CSI-RS having the strongest measured power (e.g., relative to the measured powers of the other CSI-RSs). The UE 115 may calculate a downlink shared channel power for a second CSI-RS using the scaling power value, the power offset value associated with the first CSI-RS, and measurements of the first and second reference signals. In this way, the UE 115 may properly calculate the downlink shared channel power of each CSI-RS (of each TRP), without adding a restriction to the channel measurements, and therefore enabling accurate CQI determination.

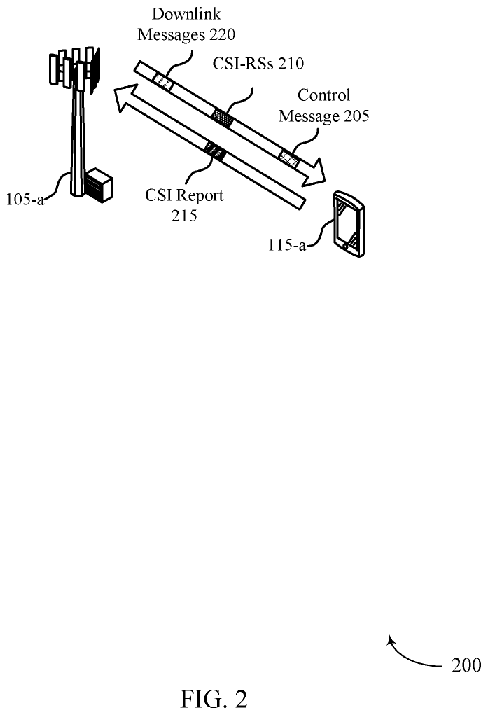

FIG. 2 illustrates an example of a wireless communications system 200 that supports power offset values for CJT mTRP communications in accordance with one or more aspects of the present disclosure. The wireless communications system 200 may implement, or be implemented by, aspects of the wireless communications system 100. For example, the wireless communications system 200 may include a network entity 105-a and a UE 115-a, which may be examples of corresponding devices described herein with reference to FIG. 1.

In some cases, the network entity 105-a (e.g., or one or more network entities 105 not shown in FIG. 2) may communicate with the UE 115-a via one or more TRPs (e.g., mTRPs). To facilitate such communications, the network entity 105-a may transmit one or more control messages 205 indicating respective configurations for CSI-RS resources. The network entity 105-a may transmit multiple CSI-RSs 210 from respective TRPs in accordance with the respective configurations, such that the UE 115-a may measure each CSI-RS 210, estimate a downlink shared channel power associated with each CSI-RS 210, and generate a CQI based on the estimated downlink shared channel powers. The UE 115-a may transmit a CSI report, indicating the CQI, to the network entity 105-a, where the network entity 105-a may use the indicated CQI to allocate power for one or more downlink shared channels.

To estimate the downlink shared channel power associated with each CSI-RS 210, the UE 115-a may use a pre-fixed power offset value associated with each CSI-RS 210. For example, the network entity 105-a may indicate, in the respective CSI-RS resource configurations, a respective pre-fixed power offset value for each CSI-RS resource. That is, if one CSI-RS resource corresponds to one TRP, then the network entity 105-a may configure one pre-fixed power offset value per TRP. However, based on using either the first mode of operation or the second mode of operation for CJT mTRP communications (e.g., Mode 1 Codebook or Mode 2 Codebook as described herein with reference to FIG. 1), the downlink shared channel power for CJT transmissions from each TRP may not be pre-determined before the UE 115-a reports the channel measurements (e.g., the values of channel measurements quantized in \tilde{W}₂ as described herein with reference to FIG. 1). That is, if the UE 115-a uses pre-fixed power offset values associated with respective CSI-RSs 210 for CQI generation, then the UE 115-a may not accurately calculate the downlink shared channel power for CJT mTRP transmissions due to restrictions placed on the channel measurements (e.g., due to restrictions placed on the PMI).

For example, in cases where CSI-RSs 210 are transmitted via two respective TRPs, the UE 115-a may calculate the downlink shared channel powers associated with each CSI-RS 210 based on the channel measurements of each CSI-RS 210 (e.g., \tilde{W}_{2,A} and \tilde{W}_{2,B} in

$${\tilde{W}}_{2} = [ \begin{matrix}{\tilde{W}}_{2 , A} \\ {\tilde{W}}_{2 , B}\end{matrix} ] ) .$$

However, if each CSI-RS (e.g., and associated TRP) is associated with a respective pre-fixed power offset value (e.g., Pc ratio), then one or more restrictions may be added onto the channel measurements of each CSI-RS. Thus, the UE 115-a may not be able to accurately calculate the CQI and may not be able to estimate the performance of the precoder (e.g., W, as described herein with reference to FIG. 1).

In some implementations of the wireless communications system 200, the network entity 105-a may configure a power offset value for a set of two or more CSI-RS resources. In such implementations, the power offset value for the set of two or more CSI-RS resources may still be a fixed power offset and represent a ratio

$$( e . g . , 10 {log}_{10} \frac{{P}_{CJT - PDSCH}}{{P}_{CSIRSset}} )$$

between a downlink shared channel power (e.g., P_{CJT-PDSCH}) and a measured power of the CSI-RS (e.g., P_{CSIRSset}).

In this way, the network entity 105 may transmit each CSI-RS 210 (e.g., via respective TRPs) with the same power. As such, the network entity 105-a may configure the power offset value for the set of two or more CSI-RS resources as a total transmission power (e.g., total energy per resource element) for a CJT downlink shared channel by all TRPs. Thus, in conjunction with the UE-reported channel measurements for each CSI-RS (e.g., quantized and represented by \tilde{W}₂), the total transmission power of the downlink shared channels associated with each CSI-RS 210 may be allocated among the TRPs associated with each CSI-RS 210.

For example, the network entity 105-a may transmit a control message 205 (e.g., such as RRC signaling) to the UE 115-a indicating a configuration for a set of two or more CSI-RS resources, where the configuration further indicates a power offset value for the set of two or more CSI-RS resources. Based on receiving the control message 205, the UE 115-a may receive, from respective TRPs, the CSI-RSs 210 associated with each CSI-RS resource and measure each CSI-RS 210. The UE 115-a may calculate a downlink shared channel power associated with each CSI-RS 210 based on the power offset value for the set of two or more CSI-RS resources. That is, the UE 115-a may use the power offset value (e.g., the same power offset value) to calculate each downlink shared channel power associated with each CSI-RS 210. In response to calculating the downlink shared channel powers, the UE 115-a may generate a CQI and transmit the CSI report 215 indicating the CQI to the network entity 105-a. The network entity 105-a may transmit, from respective TRPs, one or more downlink messages 220 via respective downlink shared channels, where the power of each downlink shared channel may be based on the CSI-report.

In some other implementations of the wireless communications system 200, the network entity 105-a may configure a threshold (e.g., maximum) power offset value for each CSI-RS resource. For example, the threshold power offset value (e.g., Pc_{max #n}) for a certain TRP associated with a certain CSI-RS 210 may represent a ratio

$$( e . g . , {Pc}_{max \# n} \geq 10 {log}_{10} \frac{{P}_{CJT - PDSCH , TRP \# n}}{{P}_{CSIRS \# n}} )$$

of the downlink shared channel power associated with the CSI-RS (e.g., P_{CJT-PDSCH,TRP #n}) and the measured power of the CSI-RS (e.g., P_{CSIRS #n}).

In such implementations, the UE 115-a may measure each CSI-RS 210 and use the threshold power offset value associated with the relatively strongest measured power CSI-RS 210 (e.g., relatively strongest measured TRP) to calculate the downlink shared channel power associated with the strongest measured CSI-RS 210 according to equation 3a (e.g., without loss of generality, here index 1 may be assumed to be the index of the strongest measured TRP) or a more general equation 3b:

$${P}_{CJT - PDSCH , TRP \#1} = {P}_{CSIRS \#1} \cdot {10}^{\frac{{Pc}_{max \#1}}{10}} \qquad ( 3 a )$$

$${P}_{CJT - PDSCH , TRP {\# n}_{strongest}} = {P}_{CSIRS {\# n}_{strongest}} \cdot {10}^{\frac{{Pc}_{max {\#n}_{strongest}}}{10}} \qquad ( 3 b )$$

where P_{CJT-PDSCH,TRP #1} or P_{CJT-PDSCH,TRP #n}_{_{strongest}} is the downlink shared channel power of the strongest measured CSI-RS 210, P_{CSIRS #1} or P_{CJT-PDSCH,TRP #n}_{_{strongest}} is the measurements of the relatively strongest measured power CSI-RS 210 (e.g., the measured power), and Pc_{max #1} or P_{CJT-PDSCH,TRP #n}_{_{strongest}} is the threshold power offset value associated with the relatively strongest measured CSI-RS 210.

The UE 115-a may calculate the downlink shared channel powers associated with the other CSI-RSs 210 based on the threshold power offset value of the strongest measured power CSI-RS 210, a scaling power parameter, and one or more measurements of the relatively strongest CSI-RS 210. That is, the UE 115-a may scale down the downlink shared channel of the other CSI-RSs 210 according to equation 4:

$${P}_{CJT - PDSCH , TRP \# n} = \frac{{P}_{{\tilde{W}}_{2} , TRP \#n}}{{P}_{{\tilde{W}}_{2} , TRP \# 1}} \cdot {P}_{CJT - PDSCH , TRP \#1} \qquad ( 4 )$$

where P_{CJT-PDSCH,TRP #n} is the downlink shared channel power of a CSI-RS 210,

$$\frac{{P}_{{\tilde{W}}_{2} , TRP \#n}}{{P}_{{\tilde{W}}_{2} , TRP \# 1}}$$

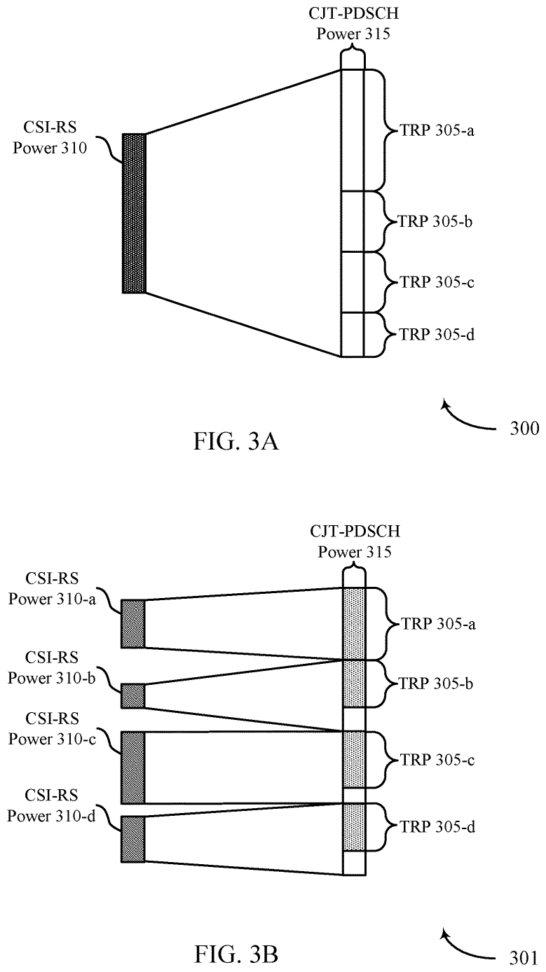

is the scaling value parameter according to the calculated \tilde{W}₂ coefficients of CJT CSI (as illustrated by equations 7 and 8 further described herein with reference to FIG. 3B), and P_{CJT-PDSCH,TRP #1} is the power of the downlink shard channel associated with the relatively strongest measured CSI-RS 210 as calculated using equation 3. The UE may calculate the scaling value parameter using techniques further described herein with reference to FIG. 3B.

For example, the network entity 105-a may transmit a control message 205 that indicates one or more configurations for CSI-RS resources, where each configurations indicates a respective threshold power offset value per CSI-RS resource. Based on the configurations, the UE 115-a may receive the CSI-RSs 210 and measure each CSI-RS 210. The UE 115-a may calculate a downlink shared channel power of the strongest measured CSI-RS 210 using the threshold power offset value associated with the CSI-RS resource that corresponds to the strongest measured CSI-RS 210 and the measurements of the strongest measured CSI-RS 210. The UE 115-a may calculate the downlink shared channel powers associated with the other CSI-RSs 210 based on the threshold power offset value of the strongest measured power CSI-RS 210, a scaling power parameter, and one or more measurements of the strongest CSI-RS 210. The UE 115-a may generate a CQI based on the measured downlink shared channels and transmit the CSI report 215, indicating the CQI, to the network entity 105-a. Based on the CQI indicated in the CSI report 215, the network entity 105-a may allocate powers to one or more CJT downlink shared channels and transmit one or more downlink messages 220 via respective TRPs to the UE 115-a. In this way, the network entity 105-a may not use a prefixed, per TRP, power offset value for CJT mTRP CSI reporting.

FIG. 3A and FIG. 3B illustrate examples of a power allocation diagram 300 and a power allocation diagram 301 that support power offset values for CJT mTRP communications in accordance with one or more aspects of the present disclosure. The power allocation diagrams 300 and 301 may implement, or be implemented by, aspects of the wireless communications system 100 and the wireless communications system 200. For example, the power allocation diagrams 300 and 301 may be implemented by a UE or a network entity using techniques described herein with reference to FIGS. 1 and 2.

FIG. 3A illustrates the power allocation diagram 300 that supports a power offset value configured for a set of two or more CSI-RS resources. For example, a UE may receive a control message (e.g., such as an RRC message) indicating respective CSI-RS resource configurations, each with a respective power offset value, but may restrict the power offset values of CSI-RS resources configured within a resource set for CJT mTRP CSI reporting to be the same. That is, the network entity may transmit separate configurations for each CSI-RS resource allocated for CJT mTRP communications, but restrict the power offset values of each CSI-RS resource to be the same (e.g., each CSI-RS resource configured for CJT mTRP communications is associated with the same power offset value, even if the power offset values are indicated in different CSI-RS resource configurations). Alternatively, a UE may receive a control message (e.g., such as RRC signaling) indicating a configuration for a set of two or more reference signals, where the configuration also indicates a single power offset value configured for a set of two or more CSI-RS resources.

Based on the configuration (or configurations) indicated in the control message, the UE may receive one or more CSI-RSs each associated with a respective TRP 305. For example, the UE may receive a first CSI-RS from the TRP 305-a, a second CSI-RS from a TRP 305-b, a third CSI-RS from the TRP 305-c, and a fourth CSI-RS from a TRP 305-d. In such examples, each TRP 305 may transmit the respective CSI-RSs with the same CSI-RS power 310, such that the UE may calculate the CJT-PDSCH power 315 associated with each TRP 305 based on the power offset value configured for the set of two or more CSI-RS resources in accordance with equation 5:

$${P}_{CJT - PDSCH} = {P}_{CSIRSset} \cdot {10}^{\frac{Pc}{10}} \qquad ( 5 )$$

Where P_{CJT-PDSCH} may be the CJT-PDSCH power 315 associated with a CSI-RS transmitted from a TRP 305, P_{CSIRSset} may represent the one or mor measurements (e.g., measured power) of the CSI-RS transmitted from the TRP 305, and Pc may be the power offset value associated with the set of two or more CSI-RS resources.

In some examples, the UE may select a subset of TRPs 305 (e.g., selects N TRPs 305) out of a total quantity of TRPs (e.g., N_{TRP}) for the PMI report. In such examples, if the UE selects the subset of TRPs 305 (e.g., selects N<N_{TRP}), then the UE may calculate the CJT-PDSCH power 315 based on the power offset value configured for the set of two or more CSI-RS resources, one or more measurements of each CSI-RS, and a scaled power parameter in accordance with equation 6:

$${P}_{CJT - PDSCH} = \frac{N}{{N}_{TRP}} \cdot {P}_{CSIRSset} \cdot {10}^{\frac{Pc}{10}} \qquad ( 6 )$$

Where P_{CJT-PDSCH} may be the CJT-PDSCH power 315 associated with a CSI-RS transmitted from a TRP 305,

$$\frac{N}{{N}_{TRP}}$$

may be the scaled power parameter, P_{CSIRSset} may represent the one or mor measurements (e.g., measured power) of the CSI-RS transmitted from the TRP 305, and Pc may be the power offset value associated with the set of two or more CSI-RS resources. In some examples, the UE may select a subset of TRPs 305 for the PMI report and calculate the CJT-PDSCH power 315 associated with each TRP of the subset of TRPs based on equation 5 and refrain from using the scaled power parameter.

Based on calculating the CJT-PDSCH power 315 associated with each TRP 305, the UE may generate a CQI and transmit a CSI report, indicating the CQI, to a network entity. In some cases, the network entity may receive the CSI report, allocate powers to one or more CJT-PDSCH based on the indicated CQI, and transmit one or more downlink messages via respective TRPs in accordance with the allocated powers.

In some cases, the network entity may not be able to apply the indicated power offset value when allocating powers for the respective CJT-PDSCHs due to a TRP 305 having a measured power (e.g., a \tilde{W}₂) that is relatively larger compared to the power of other TRPs 305, which, if implemented, may cause the power allocated to the TRP 305 to exceed an acceptable (e.g., a threshold) downlink transmission power. For example, the UE may measure the first CSI-RS associated with the TRP 305-a and determine that the measured power of the first CSI-RS is relatively larger than the measured power of the respective CSI-RSs of the TRP 305-b, TRP 305-c, and TRP 305-d. As such, the network entity may not be able to use the power offset value due to the relatively large transmission power for the TRP 305-a exceeding an acceptable downlink transmission power. In such cases, the network entity may still use the information indicated in the CQI report to schedule CJT-PDSCH powers for each TRP 305, where the network entity may use a lower modulating and coding scheme (MCS) than the one reported in the CQI (e.g., if the actual total power of each CJT-PDSCH scales down) in order for the CJT-PDSCH power 315 of the TRP 305-a to be within an acceptable power.

FIG. 3B illustrates the power allocation diagram 301 that supports a respective threshold power offset value for one or more CSI-RS resources. For example, a UE may receive a control message indicating respective configurations for one or more CSI-RS resources, where each respective configuration indicates a threshold power offset value for each CSI-RS resource of the one or more CSI-RS resources. Based on the respective configurations, the UE may receive one or more CSI-RSs each received from a respective TRP 305. For example, the UE may receive a first CSI-RS from a TRP 305-a, a second CSI-RS from a TRP 305-b, a third CSI-RS from a TRP 305-c, and a fourth CSI-RS from a TRP 305-d. In examples where each CSI-RS resource is associated with a respective threshold power offset, each TRP 305 may transmit the CSI-RSs with a respective CSI-RS power 310. That is, the TRP 305-a may transmit the first CSI-RS with a CSI-RS power 310-a. Likewise, the TRP 305-b, the TRP 305-c, and the TRP 305-d may transmit associated CSI-RSs via the CSI-RS power 310-b, the CSI-RS power 310-c, and the CSI-RS power 310-d, respectively.

Based on receiving each CSI-RS, the UE may perform one or more measurements on each CSI-RS (e.g., measure a power associated with each CSI-RS) and determine which CSI-RS has the relatively strongest measured power. As an illustrative example, the UE may measure the CSI-RS associated with each TRP 305 and determine that the CSI-RS power 310-a of the CSI-RS associated with the TRP 305-a has the relatively strongest measured power, according to the calculated \tilde{W}₂ coefficients of CJT CSI

$$( e . g . , {n}_{strongest} = arg {max}_{n} {P}_{{\tilde{W}}_{2} , TRP \# n} = 1 ,$$

where P_{\tilde{W}}_{₂}_{,TRP #n} is calculated by equation 8, as described herein with reference to FIG. 3B).

Based on measuring each CSI-RS of the one or more received CSI-RSs, the UE may use the threshold power offset value configured for the CSI-RS resource associated with the strongest measured CSI-RS in order to calculate the CJT-PDSCH power 315. For example, based on determining that the CSI-RS associated with the TRP 305-a has the strongest measured power, the UE may use the threshold power offset value associated with the TRP 305-a to calculate the CJT-PDSCH power 315 of the TRP 305-a and other TRPs 305. The UE may calculate the CJT-PDSCH power 315 of the TRP 305-a (e.g., strongest measured power TRP) based on one or more measurements of the CSI-RS associated with the TRP 305-a and the threshold power offset configured for the CSI-RS resource associated with TRP 305-a in accordance with equation 3, as described herein with reference to FIG. 2 and replicated below:

$${P}_{CJT - PDSCH , TRP \#1} = {P}_{CSIRS \#1} \cdot {10}^{\frac{{Pc}_{max \#1}}{10}} \qquad ( 3 )$$

The UE may calculate the CJT-PDSCH power 315 of the other TRPs 305 (e.g., TRP 305-b, TRP 305-c, and TRP 305-d) based on one or more measurements of each CSI-RS, the threshold power offset associated with the CSI-RS resource of the TRP 305-a, and a scaling power parameter in accordance with equation 4, as described herein with reference to FIG. 2 and replicated below:

$${P}_{CJT - PDSCH , TRP \# n} = \frac{{P}_{{\tilde{W}}_{2} , TRP \#n}}{{P}_{{\tilde{W}}_{2} , TRP \# 1}} \cdot {P}_{CJT - PDSCH , TRP \#1} \qquad ( 4 )$$

The scaling power parameter,

$$\frac{{P}_{{\tilde{W}}_{2} , TRP \#n}}{{P}_{{\tilde{W}}_{2} , TRP \# 1}} ,$$

may be calculated for each individual TRP 305 based one or more power coefficients of the individual TRPs (e.g., P_{\tilde{W}}_{₂}_{,TRP #n}) divided by one or more power coefficients of the TRP 305-a (e.g., P_{\tilde{W}}_{₂}_{,TRP #1}). The one or more power coefficients may be calculated as a squared summation of amplitudes across all the layers (e.g., transmission layers from 1.=0, . . . , rank−1). For example, the UE may calculate the one or more power coefficients for the strongest measured TRP 305 in accordance with equation 7:

$${P}_{{\tilde{W}}_{2} , TRP \# 1} = {\sum }_{l = 0}^{rank - 1} {\sum }_{i for this TRP \#1} {\sum }_{p = 0}^{1} {\sum }_{f = 0}^{M - 1} {( {p}_{l , p}^{ref} {p}_{l , i + pL , f} )}^{2} \qquad ( 7 )$$

The UE may calculate the one or more power coefficients of the other TRPs 305 in accordance with equation 8:

$${P}_{{\tilde{W}}_{2} , TRP \# n} = {\sum }_{l = 0}^{rank - 1} {\sum }_{i for this TRP \# n} {\sum }_{p = 0}^{1} {\sum }_{f = 0}^{M - 1} {( {p}_{l , p}^{ref} {p}_{l , i + pL , f} )}^{2} \qquad ( 8 )$$

In both equations 7 and 8, l may represent the layer index, i may represent the SD basis index, p may represent a polarization with a value of either a 0 or 1, L may represent the quantity of SD basis selected for the specific TRP, f may represent a FD basis index, M may represent the quantity of FD basis selected for the specific TRP,

$${p}_{l , p}^{ref}$$

may represent the reference differential amplitude of \tilde{W}₂ coefficients associated with a polarization of p and layer l, and p_{l,i+pL,f} may represent the differential amplitude of one \tilde{W}₂coefficient associated with SD basis i and FD basis f.

Further, the threshold power offset of the strongest measured TRP 305 may impact the calculation of PMI. That is, for each measured channel, prior to performing singular value decomposition (SVD), the UE may scale the measured values associated with each TRP 305, such that each measured value may be in accordance with the respective threshold power offset values (e.g., each channel measurement of each CSI-RS is within the respective threshold power offset values configured in associated CSI-RS resources). For example, before SVD, for each measured channel (e.g., H_{N}_{_{R}}_{×N}_{_{T}}=H_{N}_{_{R}}_{×2NN}_{₁}_{N}_{₂}) of each CSI-RS associated with a respective TRP 305 (e.g., each transmission port index nₜ (nₜ=0, . . . , 2N_{TRP}N₁N₂−1)) and associated with a TRP 305 (e.g., TRPₙ, n=1, . . . , N_{TRP})), each measured value should be scaled to be within the respective configured threshold power offset value (e.g., Pc_{max #n}) for alignment in accordance with equation 9:

$${H}_{{N}_{R} \times 2 {N}_{TRP} {N}_{1} {N}_{2}} = [ \begin{matrix}{H}_{{N}_{R} \times 2 {N}_{1} {N}_{2}}^{TRP \#1} \cdot {10}^{\frac{{Pc}_{max \#1}}{10}} \\ … \\ {H}_{{N}_{R} \times 2 {N}_{1} {N}_{2}}^{TRP \# N} \cdot {10}^{\frac{{Pc}_{max \# N}}{10}}\end{matrix} ] \qquad ( 9 )$$

where

$${H}_{{N}_{R} \times 2 {N}_{1} {N}_{2}}^{TRP \#1} , … , {H}_{{N}_{R} \times 2 {N}_{1} {N}_{2}}^{TRP \# N}$$

may represent the original channel measurements for the TRPs 305 (e.g., TRP₁, . . . , TRP_{N}) without being scaled by the threshold power offset value. After scaling each channel measurements according to the respective threshold power offsets, the UE may perform SD compression, SVD, and FD compression. In such examples, the configured threshold power offset values may impact PMI calculation, by impacting SD basis selection (e.g., a selection of Lₜₒₜ strongest SD bases, which may be according to H_{N}_{_{R}}_{×2N}_{_{TRP}}_{N}_{₁}_{N}_{₂} and be aligned by respective threshold power offset values P_{cmax #n}, where n=1, . . . , N_{TRP}) and TRP selection.

The UE may generate the CQI based on calculating the CJT-PDSCH power 315 of each TRP 305. The UE may transmit a CSI report indicating the CQI to the network entity, where the network entity may use the indicated CQI to allocate power to one or more CJT-PDSCH for respective TRPs. The techniques of FIG. 3B may have more flexibility than those of FIG. 3A due to each different TRP 305 having the ability to power-boost the respective CSI-RSs, thereby requiring different threshold power offset values.

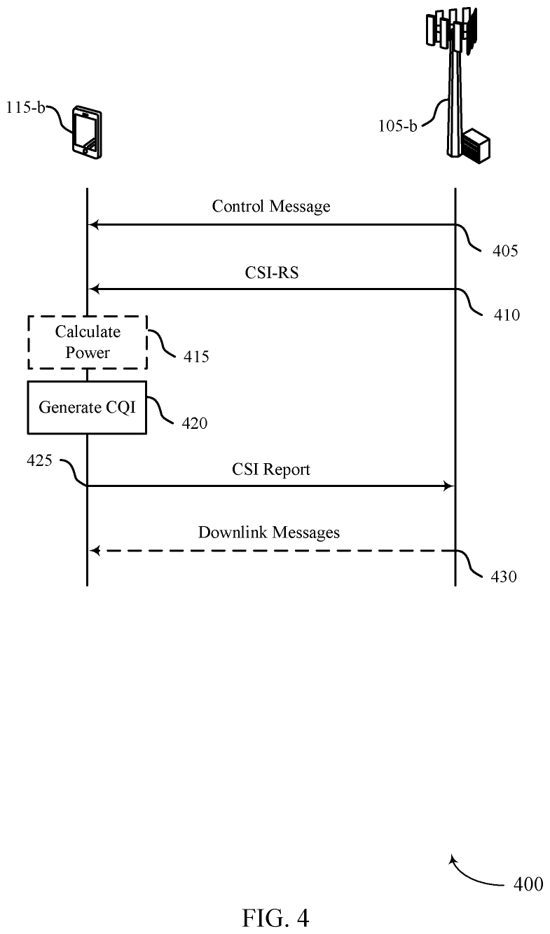

FIG. 4 illustrates an example of a process flow 400 that supports power offset values for CJT mTRP communications in accordance with one or more aspects of the present disclosure. Aspects of the process flow 400 may implement, or be implemented by aspects of the wireless communications system 100, the wireless communications system 200, the power allocation diagram 300, and the power allocation diagram 301. For example, the process flow 400 may include a network entity 105-b and a UE 115-b, which may be examples of corresponding devices described herein with reference to FIGS. 1 through 3B. In the following description of the process flow 400, the operations may be performed in a different order than the order shown. Specific operations also may be left out of the process flow 400, or other operations may be added to the process flow 400. Further, although some operations or signaling may be shown to occur at different times for discussion purposes, these operations may actually occur at the same time.

At 405, the UE 115-b may receive a control message (e.g., such as an RRC message) indicating a configuration for a set of two or more reference signal resources (e.g., CSI-RS resources or NZP-CSI-RS resources), where the configuration further indicates a power offset value for the set of two or more reference signal resources. In some examples, the configuration may indicate a respective offset value for each reference signal of the set of two or more reference signals, where each respective power offset value are equal based on the set of two or more reference signals being allocated for CJT mTRP communications.

At 410, the UE 115-b may receive one or more reference signals (e.g., CSI-RSs 210 or NZP-CSI-RSs) based on the received configuration, where each reference signal is associated with a respective TRP. In such examples, the network entity 105-b may transmit each reference signal at the same (e.g., equivalent) power.

At 415, the UE 115-b may calculate a power associated with a downlink channel (e.g., power for a CJT-PDSCH) for each reference signal. In some examples, the UE 115-b may calculate the downlink shared channel power for each reference signal based on the power offset value configured for the set of two or more reference signal resources and one or more measurements of each reference signal in accordance with equation 5 as described in FIG. 3A. In some other examples, the UE 115-b may select a subset of the set of two or more reference signals and calculate the downlink shared channel power for each reference signal of the subset based on the power offset value for the set of two or more reference signals, one or more measurements of each reference signal, and a scaled power parameter in accordance with equation 6 as described in FIG. 3A.

At 420, the UE 115-b may generate a CQI based on the power offset value for the set of two or more reference signal resources and one or more measurements of each reference signal. That is, the UE 115-b may generate a CQI based on the calculated downlink shared channel powers associated with each reference signal of the one or more reference signals. At 425, the UE 115-b may transmit a CSI report indicating the CQI. At 430, the network entity 105-b may transmit one or more downlink messages via at least two or more CJT downlink shared channels, where a power associated with each CJT downlink shared channel is based on the CSI report.

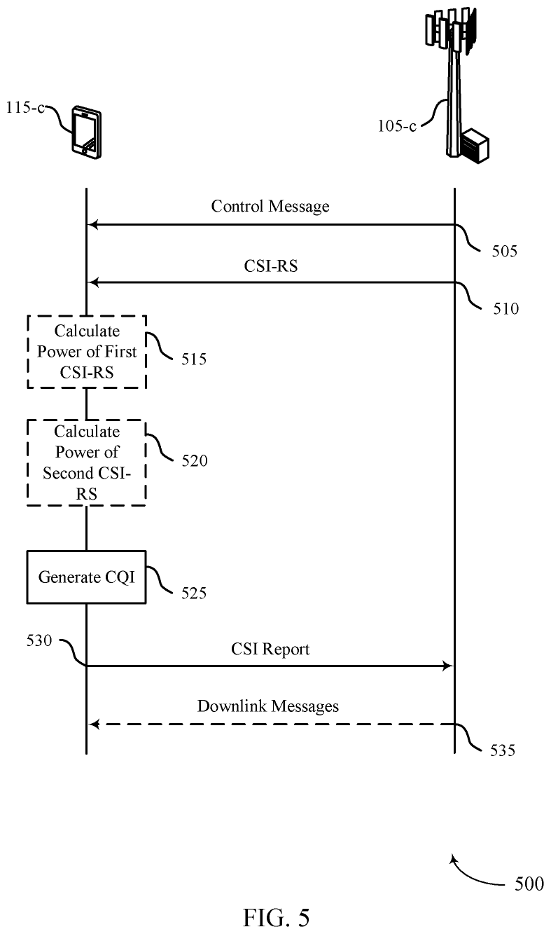

FIG. 5 illustrates an example of a process flow 500 that supports power offset values for CJT mTRP communications in accordance with one or more aspects of the present disclosure. Aspects of the process flow 500 may implement, or be implemented by aspects of the wireless communications system 100, the wireless communications system 200, the power allocation diagram 300, and the power allocation diagram 301. For example, the process flow 500 may include a network entity 105-c and a UE 115-c, which may be examples of corresponding devices described herein with reference to FIGS. 1 through 3B. In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time.

At 505, the UE 115-c may receive a control message (e.g., such as an RRC message) indicating respective configurations for one or more reference signal resources (e.g., CSI-RS resources), where the respective configurations indicate a respective threshold power offset value (e.g., Pc Ratio or powerControlOffset) for each reference signal resource of the one or more reference signal resources.

At 510, the UE 115-c may receive one or more reference signals (e.g., CSI-RSs or NZP-CSI-RSs) based at least in part on the respective configurations, where each reference signal of the one or more reference signal is associated with a respective TRP. That is, each reference signal of the one or more reference signals may be transmitted by a respective TRP and received based on one or more parameters indicated in the reference signal resource configuration. Based on receiving the one or more reference signals, the UE 115-c may perform channel measurements on each reference signal (e.g., measure the power of each reference signal).

At 515, the UE 115-c may calculate the power associated with a downlink channel of a first reference signal based on one or more channel measurements of the first reference signal and a threshold power offset value associated with a first reference signal resource, where the first reference signal is associated with the first reference signal resource. That is, based on measuring each reference signal, the UE 115-c may determine that the first reference signal satisfies a power threshold (e.g., the power threshold being the strongest measured power reference signal relative to the other reference signals) and use the threshold power offset value associated with the first reference signal resource (e.g., that is used to receive the first reference signal) to calculate the downlink shared channel power associated with the first reference signal according to equation 3, as described herein with reference to FIG. 2.

At 520, the UE 115-c may calculate a power associated with a downlink channel associated with a second reference signal based on the threshold power offset value associated with the first reference signal resource (e.g., the first reference signal resource being used to receive the first reference signal), a scaling power parameter associated with the second reference signal, and one or more measurements of the first reference signal and the second reference signal according to equation 4, as described herein with reference to FIG. 2. In order to calculate the scaling power parameter associated with the second reference signal, the UE 115-c may calculate one or more power coefficients of the first reference signal based on a squared summation of measured amplitudes across the first reference signal, according to equation X, as described herein with reference to FIG. 3B. Likewise, the UE 115-c may calculate one or more power coefficients of the second reference signal based on a squared summation of measured amplitudes across the second reference signal, according to equation 7, as described herein with reference to FIG. 3B. To calculate the scaling power parameter associated with the second reference signal, the UE 115-c may divide the power coefficients of the second reference signal by the one or more power coefficients of the first reference signal in accordance with equation 8, as described herein with reference to FIG. 3B.

In some examples, the UE 115-c may determine an estimated channel measurement for a channel between the UE 115-c and a first TRP associated with the first reference signal based on the threshold power offset value associated with the first reference signal resource. In such examples, the UE 115-c may calculate a PMI based on the estimated channel measurements. Likewise, the UE 115-c may determine an estimated channel measurement for a channel between the UE 115-c and a second TRP (e.g., different from the first TRP) based on the threshold power offset value associated with the first reference signal. In such examples, the UE 115-c may calculate a PMI for the second reference signal based on the estimated channel measurements.

At 525, the UE 115-c may generate a CQI based on the measurements of each reference signal, the threshold power offset value associated with the first reference signal resource, the scaling power parameter associated with the second reference signal resource (e.g., a subset of the configured reference signal resources). That is, the UE 115-c may generate the CQI based on the calculated powers associated with each reference signal, the PMIs associated with each reference signal, or a combination thereof.

At 530, the UE 115-c may transmit, to the network entity 105-c, a CSI report that includes at least the CQI. At 535, the network entity 105-c may transmit one or more downlink messages via CJT downlink shared channels in accordance with the CSI report. For example, the power of each CJT downlink shared channel may be based on the CQI indicated in the CSI report.

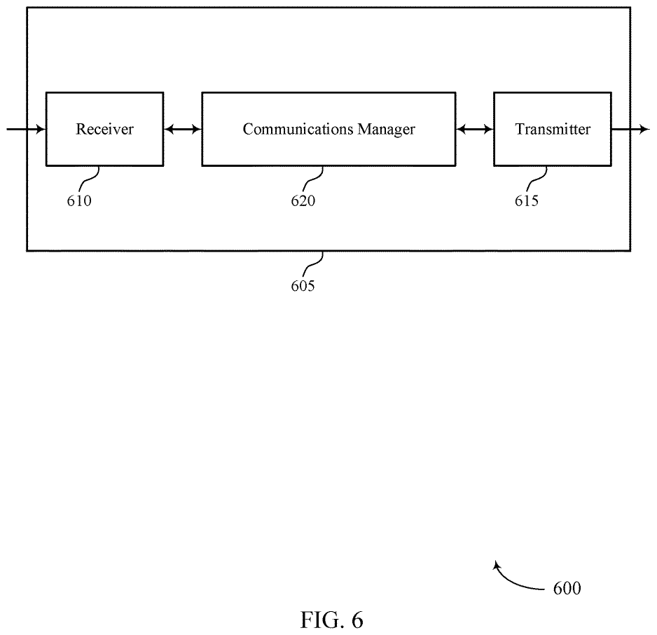

FIG. 6 illustrates a block diagram 600 of a device 605 that supports power offset values for CJT mTRP communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power offset values for CJT mTRP communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power offset values for CJT mTRP communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of power offset values for CJT mTRP communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a control message indicating a configuration for a set of two or more reference signal resources, the configuration including a power offset value for the set of two or more reference signal resources. The communications manager 620 may be configured as or otherwise support a means for receiving one or more reference signals based on the configuration of the set of two or more reference signal resources, where each reference signal of the one or more reference signals is associated with a respective TRP. The communications manager 620 may be configured as or otherwise support a means for generating a CQI based on the power offset value for the set of two or more reference signal resources and one or more measurements of each reference signal of the one or more reference signals. The communications manager 620 may be configured as or otherwise support a means for transmitting a CSI report including the CQI.

Additionally, or alternatively, the communications manager 620 may support wireless communication at a UE in accordance with examples as disclosed herein. For example, the communications manager 620 may be configured as or otherwise support a means for receiving a control message indicating respective configurations for one or more reference signal resources, the respective configurations including respective threshold power offset values for each reference signal resource of the one or more reference signal resources. The communications manager 620 may be configured as or otherwise support a means for receiving one or more reference signals based on the respective configurations, where each reference signal of the one or more reference signals is associated with a respective TRP. The communications manager 620 may be configured as or otherwise support a means for generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The communications manager 620 may be configured as or otherwise support a means for transmitting a CSI report including the CQI.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for improved power offset values for CJT mTRP systems, which may lead to more efficient utilization of communication resources.

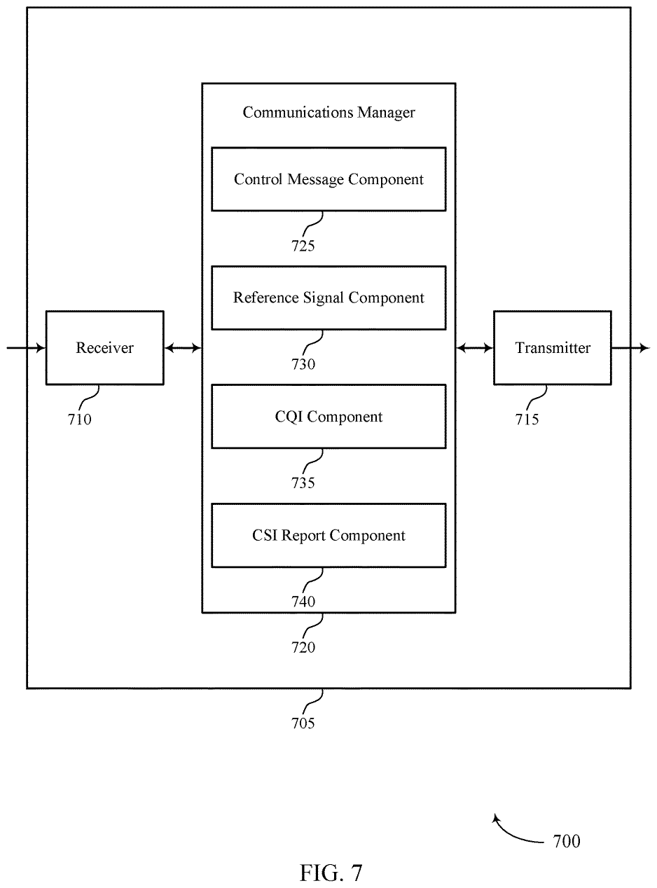

FIG. 7 illustrates a block diagram 700 of a device 705 that supports power offset values for CJT mTRP communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to power offset values for CJT mTRP communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to power offset values for CJT mTRP communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of power offset values for CJT mTRP communications as described herein. For example, the communications manager 720 may include a control message component 725, a reference signal component 730, a CQI component 735, a CSI report component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control message component 725 may be configured as or otherwise support a means for receiving a control message indicating a configuration for a set of two or more reference signal resources, the configuration including a power offset value for the set of two or more reference signal resources. The reference signal component 730 may be configured as or otherwise support a means for receiving one or more reference signals based on the configuration of the set of two or more reference signal resources, where each reference signal of the one or more reference signals is associated with a respective TRP. The CQI component 735 may be configured as or otherwise support a means for generating a CQI based on the power offset value for the set of two or more reference signal resources and one or more measurements of each reference signal of the one or more reference signals. The CSI report component 740 may be configured as or otherwise support a means for transmitting a CSI report including the CQI.

Additionally, or alternatively, the communications manager 720 may support wireless communication at a UE in accordance with examples as disclosed herein. The control message component 725 may be configured as or otherwise support a means for receiving a control message indicating respective configurations for one or more reference signal resources, the respective configurations including respective threshold power offset values for each reference signal resource of the one or more reference signal resources. The reference signal component 730 may be configured as or otherwise support a means for receiving one or more reference signals based on the respective configurations, where each reference signal of the one or more reference signals is associated with a respective TRP. The CQI component 735 may be configured as or otherwise support a means for generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The CSI report component 740 may be configured as or otherwise support a means for transmitting a CSI report including the CQI.

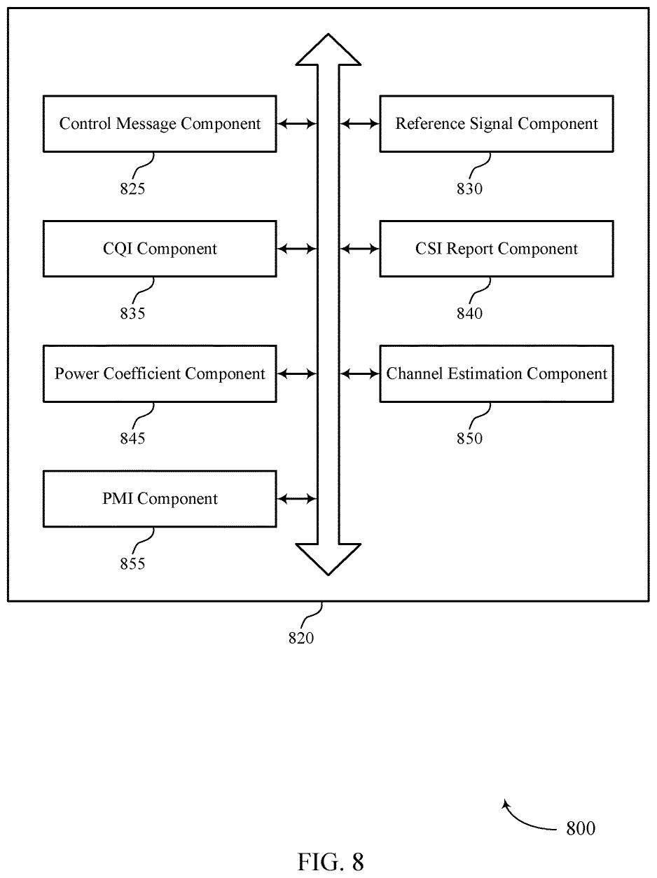

FIG. 8 illustrates a block diagram 800 of a communications manager 820 that supports power offset values for CJT mTRP communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of power offset values for CJT mTRP communications as described herein. For example, the communications manager 820 may include a control message component 825, a reference signal component 830, a CQI component 835, a CSI report component 840, a power coefficient component 845, a channel estimation component 850, a PMI component 855, or any combination thereof. Each of these components may communicate, directly or indirectly, with one another (e.g., via one or more buses).

The communications manager 820 may support wireless communication at a UE in accordance with examples as disclosed herein. The control message component 825 may be configured as or otherwise support a means for receiving a control message indicating a configuration for a set of two or more reference signal resources, the configuration including a power offset value for the set of two or more reference signal resources. The reference signal component 830 may be configured as or otherwise support a means for receiving one or more reference signals based on the configuration of the set of two or more reference signal resources, where each reference signal of the one or more reference signals is associated with a respective TRP. The CQI component 835 may be configured as or otherwise support a means for generating a CQI based on the power offset value for the set of two or more reference signal resources and one or more measurements of each reference signal of the one or more reference signals. The CSI report component 840 may be configured as or otherwise support a means for transmitting a CSI report including the CQI.

In some examples, to support generating the CQI, the CQI component 835 may be configured as or otherwise support a means for calculating a power associated with a downlink shared channel for each reference signal of the one or more reference signals based on the power offset value for the set of two or more reference signal resources and the one or more measurements, where the CQI is based on the power of the downlink shared channel for each reference signal of the one or more reference signals.

In some examples, to support generating the CQI, the CQI component 835 may be configured as or otherwise support a means for calculating a power associated with a downlink shared channel for each reference signal of the one or more reference signals based on the power offset value for the set of two or more reference signal resources, the one or more measurements, and a scaled power of the set of two or more reference signal resources, where the scaled power is based on a quantity of UE-selected TRPs from a total quantity of TRPs.

In some examples, to support receiving the control message indicating the configuration, the control message component 825 may be configured as or otherwise support a means for receiving the control message indicating a respective power offset value for each reference signal resource of the set of two or more reference signal resources, where the power offset value for each reference signal resource of the set of two or more reference signal resources are equal based on the set of two or more reference signal resources being associated with a CJT by mTRPs.

In some examples, each reference signal of the one or more reference signals are transmitted at an equal power based on the power offset value for the set of two or more reference signal resources.

In some examples, the set of two or more reference signal resources includes a CSI reference signal resource set.

In some examples, the control message includes a RRC message.

Additionally, or alternatively, the communications manager 820 may support wireless communication at a UE in accordance with examples as disclosed herein. In some examples, the control message component 825 may be configured as or otherwise support a means for receiving a control message indicating respective configurations for one or more reference signal resources, the respective configurations including respective threshold power offset values for each reference signal resource of the one or more reference signal resources. In some examples, the reference signal component 830 may be configured as or otherwise support a means for receiving one or more reference signals based on the respective configurations, where each reference signal of the one or more reference signals is associated with a respective TRP. In some examples, the CQI component 835 may be configured as or otherwise support a means for generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. In some examples, the CSI report component 840 may be configured as or otherwise support a means for transmitting a CSI report including the CQI.

In some examples, to support generating the CQI, the CQI component 835 may be configured as or otherwise support a means for calculating a power associated with a downlink shared channel of the first reference signal based on the threshold power offset value associated with the first reference signal resource and one or more measurements of the first reference signal.

In some examples, to support generating the CQI, the CQI component 835 may be configured as or otherwise support a means for calculating a power associated with a downlink shared channel associated with a second reference signal based on the power offset value associated with the first reference signal resource, a scaling power parameter associated with the second reference signal, and one or more measurements of the first reference signal and of the second reference signal.

In some examples, the power coefficient component 845 may be configured as or otherwise support a means for calculating one or more power coefficients of the first reference signal based on a squared summation of measured amplitudes across the first reference signal. In some examples, the power coefficient component 845 may be configured as or otherwise support a means for calculating one or more power coefficients of a second reference signal based on a squared summation of measured amplitudes across the second reference signal.

In some examples, the scaling power parameter is the one or more power coefficients of the second reference signal divided by the one or more power coefficients of the first reference signal.

In some examples, the channel estimation component 850 may be configured as or otherwise support a means for determining an estimated channel measurement for a channel between the UE and a first TRP associated with the first reference signal, where the estimated channel measurement is based on the threshold power offset value associated with the first reference signal resource. In some examples, the PMI component 855 may be configured as or otherwise support a means for calculating a PMI based on the estimated channel measurement.

In some examples, the channel estimation component 850 may be configured as or otherwise support a means for determining an estimated channel measurement for a channel between the UE and a second TRP different from a first TRP associated with the first reference signal, the second TRP being associated with a reference signal from the subset of the one or more reference signals, where the estimated channel measurement is based on the threshold power offset value associated with the first reference signal resource and the scaling power parameter. In some examples, the PMI component 855 may be configured as or otherwise support a means for calculating a PMI based on the estimated channel measurement.

In some examples, the one or more reference signal resources includes CSI reference signal resources.

In some examples, the control message includes a RRC message.

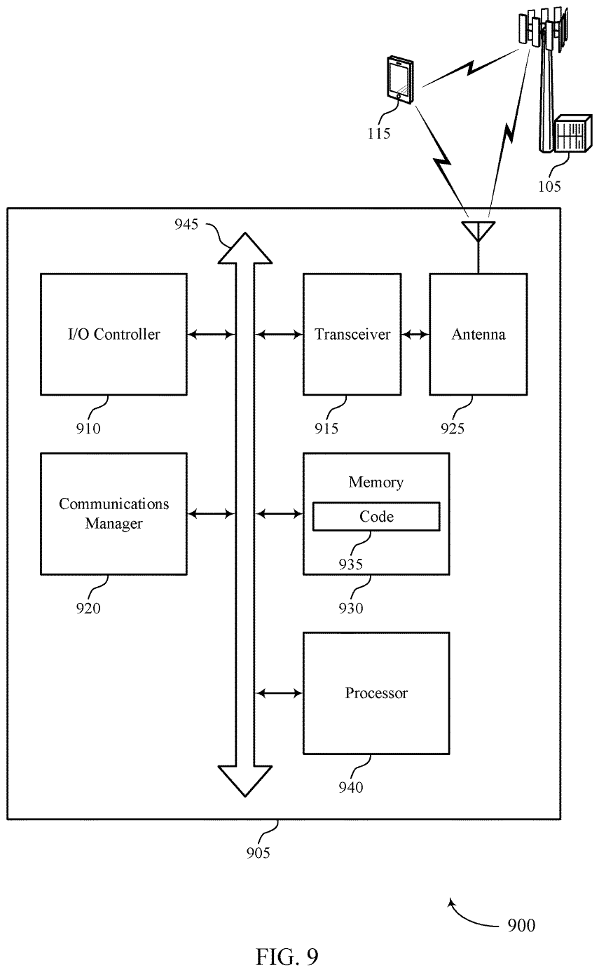

FIG. 9 illustrates a diagram of a system 900 including a device 905 that supports power offset values for CJT mTRP communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOSR, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting power offset values for CJT mTRP communications). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a control message indicating a configuration for a set of two or more reference signal resources, the configuration including a power offset value for the set of two or more reference signal resources. The communications manager 920 may be configured as or otherwise support a means for receiving one or more reference signals based on the configuration of the set of two or more reference signal resources, where each reference signal of the one or more reference signals is associated with a respective TRP. The communications manager 920 may be configured as or otherwise support a means for generating a CQI based on the power offset value for the set of two or more reference signal resources and one or more measurements of each reference signal of the one or more reference signals. The communications manager 920 may be configured as or otherwise support a means for transmitting a CSI report including the CQI.

Additionally, or alternatively, the communications manager 920 may support wireless communication at a UE in accordance with examples as disclosed herein. For example, the communications manager 920 may be configured as or otherwise support a means for receiving a control message indicating respective configurations for one or more reference signal resources, the respective configurations including respective threshold power offset values for each reference signal resource of the one or more reference signal resources. The communications manager 920 may be configured as or otherwise support a means for receiving one or more reference signals based on the respective configurations, where each reference signal of the one or more reference signals is associated with a respective TRP. The communications manager 920 may be configured as or otherwise support a means for generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The communications manager 920 may be configured as or otherwise support a means for transmitting a CSI report including the CQI.

By including or configuring the communications manager 920 in accordance with examples as described herein, the device 905 may support techniques for improved power offset values for CJT mTRP systems, which may lead to improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of power offset values for CJT mTRP communications as described herein, or the processor 940 and the memory 930 may be otherwise configured to perform or support such operations.

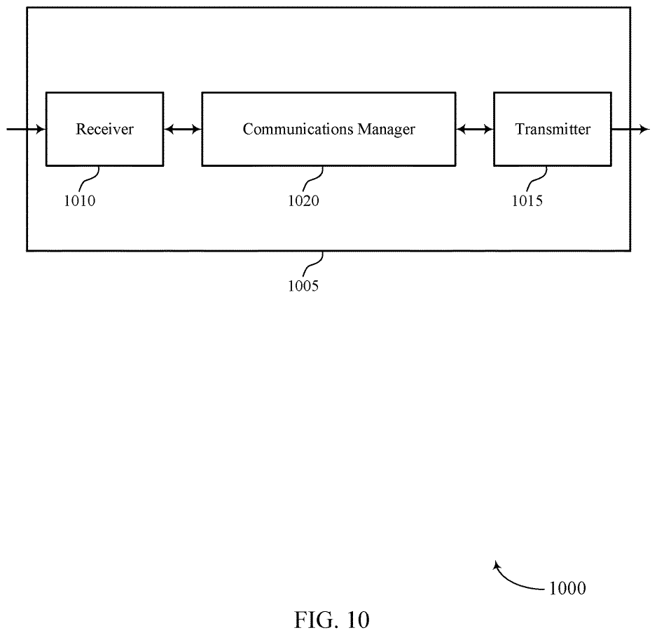

FIG. 10 illustrates a block diagram 1000 of a device 1005 that supports power offset values for CJT mTRP communications in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of power offset values for CJT mTRP communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting a control message indicating a configuration for a set of two or more reference signal resources, the configuration including a power offset value for the set of two or more reference signal resources. The communications manager 1020 may be configured as or otherwise support a means for transmitting one or more reference signals based on the configuration of the set of two or more reference signal resources, where each reference signal of the one or more reference signals is associated with a respective TRP at the network entity. The communications manager 1020 may be configured as or otherwise support a means for receiving a CSI report including a CQI, where the CQI is based on the power offset value for the set of two or more reference signal resources and one or more measurements of each reference signal of the one or more reference signals.

Additionally, or alternatively, the communications manager 1020 may support wireless communication at a network entity in accordance with examples as disclosed herein. For example, the communications manager 1020 may be configured as or otherwise support a means for transmitting a control message indicating respective configurations for one or more reference signal resources, the respective configurations including respective threshold power offset values for each reference signal resource of the one or more reference signal resources. The communications manager 1020 may be configured as or otherwise support a means for transmitting one or more reference signals based on the respective configurations, where each reference signal of the one or more reference signals is associated with a respective TRP. The communications manager 1020 may be configured as or otherwise support a means for receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for improved power offset values for CJT mTRP systems, which may lead to more efficient utilization of communication resources.

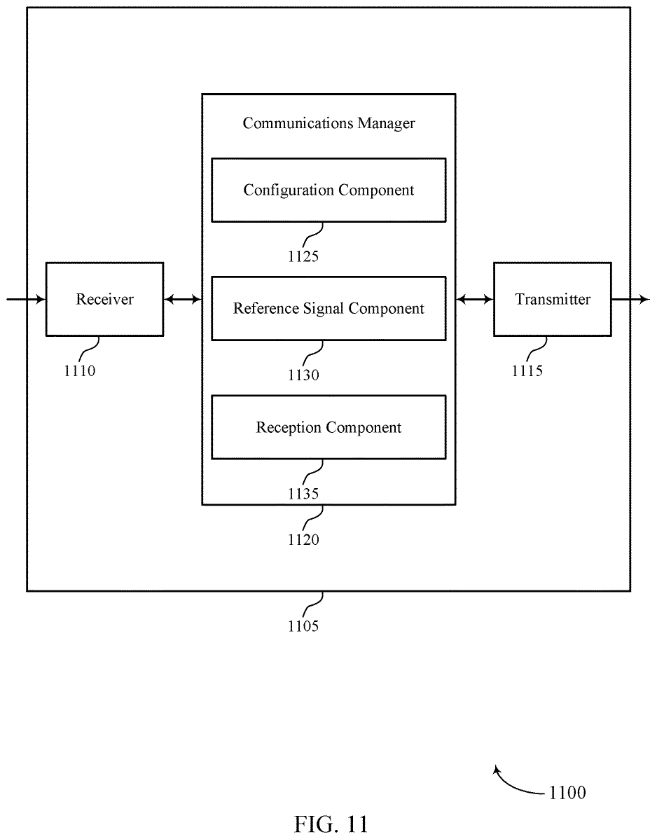

FIG. 11 illustrates a block diagram 1100 of a device 1105 that supports power offset values for CJT mTRP communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of power offset values for CJT mTRP communications as described herein. For example, the communications manager 1120 may include a configuration component 1125, a reference signal component 1130, a reception component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The configuration component 1125 may be configured as or otherwise support a means for transmitting a control message indicating a configuration for a set of two or more reference signal resources, the configuration including a power offset value for the set of two or more reference signal resources. The reference signal component 1130 may be configured as or otherwise support a means for transmitting one or more reference signals based on the configuration of the set of two or more reference signal resources, where each reference signal of the one or more reference signals is associated with a respective TRP at the network entity. The reception component 1135 may be configured as or otherwise support a means for receiving a CSI report including a CQI, where the CQI is based on the power offset value for the set of two or more reference signal resources and one or more measurements of each reference signal of the one or more reference signals.

Additionally, or alternatively, the communications manager 1120 may support wireless communication at a network entity in accordance with examples as disclosed herein. The configuration component 1125 may be configured as or otherwise support a means for transmitting a control message indicating respective configurations for one or more reference signal resources, the respective configurations including respective threshold power offset values for each reference signal resource of the one or more reference signal resources. The reference signal component 1130 may be configured as or otherwise support a means for transmitting one or more reference signals based on the respective configurations, where each reference signal of the one or more reference signals is associated with a respective TRP. The reception component 1135 may be configured as or otherwise support a means for receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

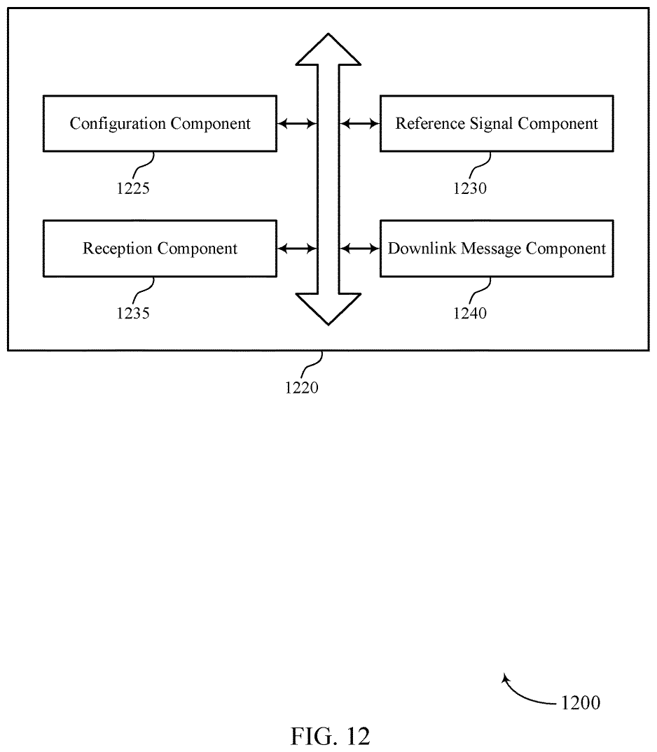

FIG. 12 illustrates a block diagram 1200 of a communications manager 1220 that supports power offset values for CJT mTRP communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of power offset values for CJT mTRP communications as described herein. For example, the communications manager 1220 may include a configuration component 1225, a reference signal component 1230, a reception component 1235, a downlink message component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration component 1225 may be configured as or otherwise support a means for transmitting a control message indicating a configuration for a set of two or more reference signal resources, the configuration including a power offset value for the set of two or more reference signal resources. The reference signal component 1230 may be configured as or otherwise support a means for transmitting one or more reference signals based on the configuration of the set of two or more reference signal resources, where each reference signal of the one or more reference signals is associated with a respective TRP at the network entity. The reception component 1235 may be configured as or otherwise support a means for receiving a CSI report including a CQI, where the CQI is based on the power offset value for the set of two or more reference signal resources and one or more measurements of each reference signal of the one or more reference signals.

In some examples, to support transmitting the control message indicating the configuration, the configuration component 1225 may be configured as or otherwise support a means for transmitting the control message indicating a respective power offset value for each reference signal resource of the set of two or more reference signal resources, where the power offset value for each reference signal resource of the set of two or more reference signal resources are equal based on the set of two or more reference signal resources being associated with a CJT by mTRPs.

In some examples, each reference signal of the one or more reference signals are transmitted at an equal power based on the power offset value of the set of two or more reference signal resources.

In some examples, the downlink message component 1240 may be configured as or otherwise support a means for transmitting one or more downlink messages associated with the one or more reference signals, the one or more downlink messages being associated with a CJT downlink scheme, where a power associated with each of the one or more downlink messages is based on the CSI report.

In some examples, the set of two or more reference signal resources includes a CSI reference signal resource set.

In some examples, the control message includes a RRC message.

Additionally, or alternatively, the communications manager 1220 may support wireless communication at a network entity in accordance with examples as disclosed herein. In some examples, the configuration component 1225 may be configured as or otherwise support a means for transmitting a control message indicating respective configurations for one or more reference signal resources, the respective configurations including respective threshold power offset values for each reference signal resource of the one or more reference signal resources. In some examples, the reference signal component 1230 may be configured as or otherwise support a means for transmitting one or more reference signals based on the respective configurations, where each reference signal of the one or more reference signals is associated with a respective TRP. In some examples, the reception component 1235 may be configured as or otherwise support a means for receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

In some examples, the downlink message component 1240 may be configured as or otherwise support a means for transmitting one or more downlink messages associated with the one or more reference signals, the one or more downlink messages being associated with a CJT downlink scheme, where a power associated with each of the one or more downlink messages is based on the CSI report.

In some examples, the one or more reference signal resources includes a CSI reference signal resource set.

In some examples, the control message includes a RRC message.

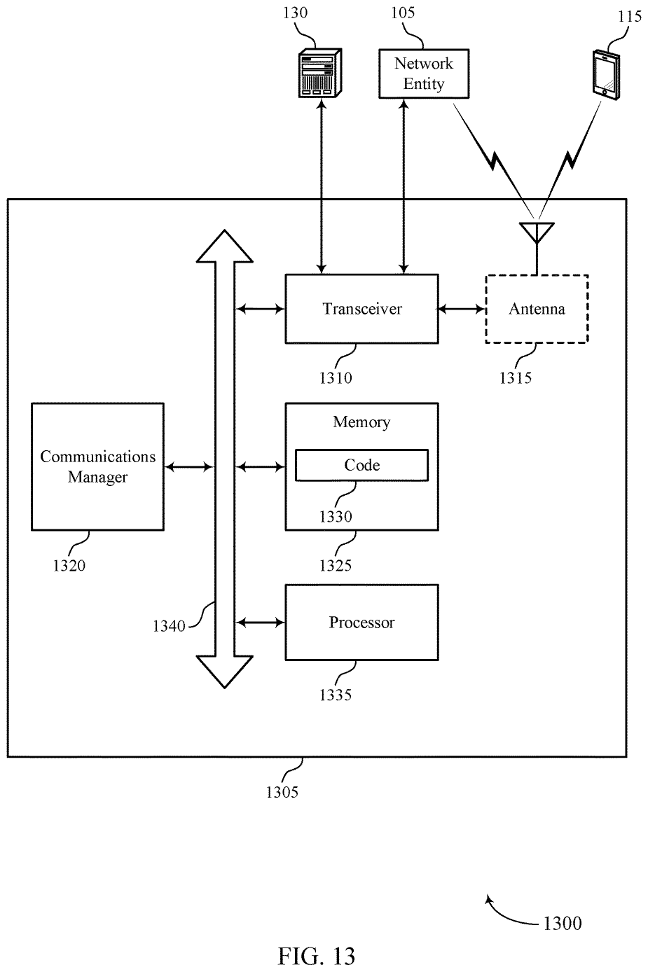

FIG. 13 illustrates a diagram of a system 1300 including a device 1305 that supports power offset values for CJT mTRP communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting power offset values for CJT mTRP communications). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting a control message indicating a configuration for a set of two or more reference signal resources, the configuration including a power offset value for the set of two or more reference signal resources. The communications manager 1320 may be configured as or otherwise support a means for transmitting one or more reference signals based on the configuration of the set of two or more reference signal resources, where each reference signal of the one or more reference signals is associated with a respective TRP at the network entity. The communications manager 1320 may be configured as or otherwise support a means for receiving a CSI report including a CQI, where the CQI is based on the power offset value for the set of two or more reference signal resources and one or more measurements of each reference signal of the one or more reference signals.

Additionally, or alternatively, the communications manager 1320 may support wireless communication at a network entity in accordance with examples as disclosed herein. For example, the communications manager 1320 may be configured as or otherwise support a means for transmitting a control message indicating respective configurations for one or more reference signal resources, the respective configurations including respective threshold power offset values for each reference signal resource of the one or more reference signal resources. The communications manager 1320 may be configured as or otherwise support a means for transmitting one or more reference signals based on the respective configurations, where each reference signal of the one or more reference signals is associated with a respective TRP. The communications manager 1320 may be configured as or otherwise support a means for receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource.

By including or configuring the communications manager 1320 in accordance with examples as described herein, the device 1305 may support techniques for improved power offset values for CJT mTRP systems, which may lead to improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of power offset values for CJT mTRP communications as described herein, or the processor 1335 and the memory 1325 may be otherwise configured to perform or support such operations.

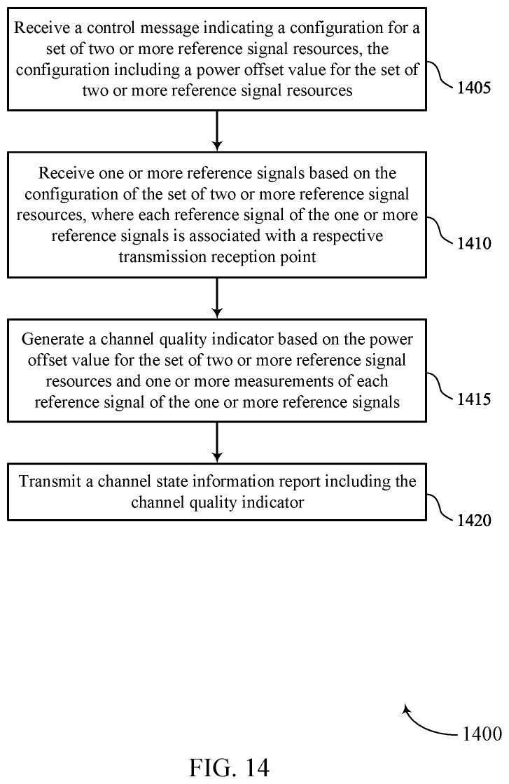

FIG. 14 illustrates a flowchart showing a method 1400 that supports power offset values for CJT mTRP communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a configuration for a set of two or more reference signal resources, the configuration including a power offset value for the set of two or more reference signal resources. The operations of 1405 may be performed in accordance with examples as disclosed herein. In some examples, aspects of the operations of 1405 may be performed by a control message component 825 as described with reference to FIG. 8.

At 1410, the method may include receiving one or more reference signals based on the configuration of the set of two or more reference signal resources, where each reference signal of the one or more reference signals is associated with a respective TRP. The operations of 1410 may be performed in accordance with examples as disclosed herein. In some examples, aspects of the operations of 1410 may be performed by a reference signal component 830 as described with reference to FIG. 8.

At 1415, the method may include generating a CQI based on the power offset value for the set of two or more reference signal resources and one or more measurements of each reference signal of the one or more reference signals. The operations of 1415 may be performed in accordance with examples as disclosed herein. In some examples, aspects of the operations of 1415 may be performed by a CQI component 835 as described with reference to FIG. 8.

At 1420, the method may include transmitting a CSI report including the CQI. The operations of 1420 may be performed in accordance with examples as disclosed herein. In some examples, aspects of the operations of 1420 may be performed by a CSI report component 840 as described with reference to FIG. 8.

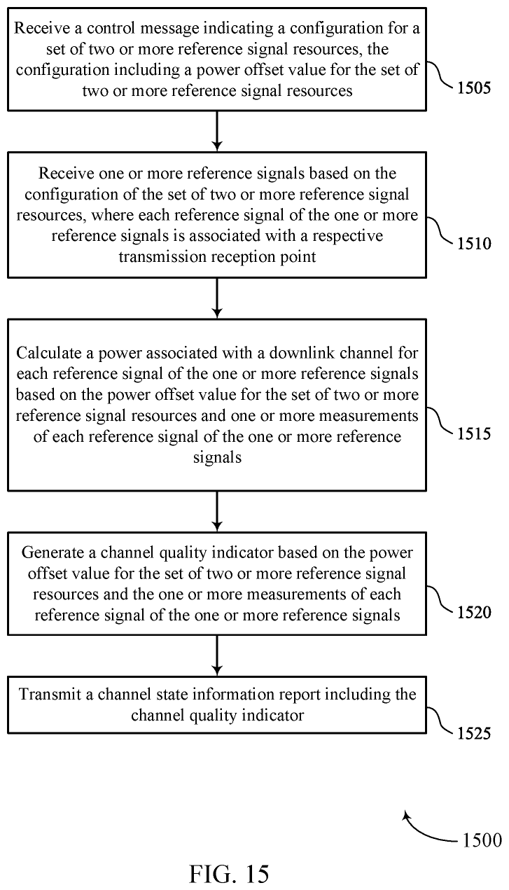

FIG. 15 illustrates a flowchart showing a method 1500 that supports power offset values for CJT mTRP communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a configuration for a set of two or more reference signal resources, the configuration including a power offset value for the set of two or more reference signal resources. The operations of 1505 may be performed in accordance with examples as disclosed herein. In some examples, aspects of the operations of 1505 may be performed by a control message component 825 as described with reference to FIG. 8.

At 1510, the method may include receiving one or more reference signals based on the configuration of the set of two or more reference signal resources, where each reference signal of the one or more reference signals is associated with a respective TRP. The operations of 1510 may be performed in accordance with examples as disclosed herein. In some examples, aspects of the operations of 1510 may be performed by a reference signal component 830 as described with reference to FIG. 8.

At 1515, the method may include calculating a power associated with a downlink shared channel for each reference signal of the one or more reference signals based on the power offset value for the set of two or more reference signal resources and one or more measurements of each reference signal of the one or more reference signals. The operations of 1515 may be performed in accordance with examples as disclosed herein. In some examples, aspects of the operations of 1515 may be performed by a CQI component 835 as described with reference to FIG. 8.

At 1520, the method may include generating a CQI based on the power offset value for the set of two or more reference signal resources and the one or more measurements of each reference signal of the one or more reference signals. The operations of 1520 may be performed in accordance with examples as disclosed herein. In some examples, aspects of the operations of 1520 may be performed by a CQI component 835 as described with reference to FIG. 8.

At 1525, the method may include transmitting a CSI report including the CQI. The operations of 1525 may be performed in accordance with examples as disclosed herein. In some examples, aspects of the operations of 1525 may be performed by a CSI report component 840 as described with reference to FIG. 8.

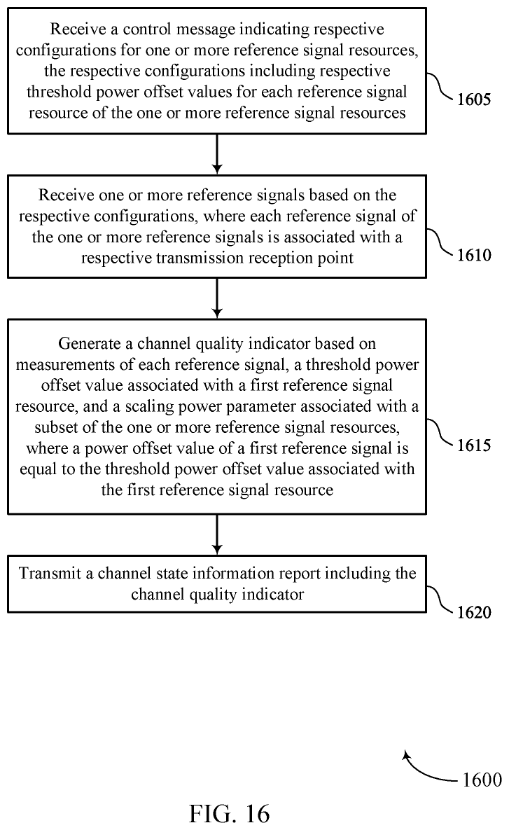

FIG. 16 illustrates a flowchart showing a method 1600 that supports power offset values for CJT mTRP communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating respective configurations for one or more reference signal resources, the respective configurations including respective threshold power offset values for each reference signal resource of the one or more reference signal resources. The operations of 1605 may be performed in accordance with examples as disclosed herein. In some examples, aspects of the operations of 1605 may be performed by a control message component 825 as described with reference to FIG. 8.

At 1610, the method may include receiving one or more reference signals based on the respective configurations, where each reference signal of the one or more reference signals is associated with a respective TRP. The operations of 1610 may be performed in accordance with examples as disclosed herein. In some examples, aspects of the operations of 1610 may be performed by a reference signal component 830 as described with reference to FIG. 8.

At 1615, the method may include generating a CQI based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The operations of 1615 may be performed in accordance with examples as disclosed herein. In some examples, aspects of the operations of 1615 may be performed by a CQI component 835 as described with reference to FIG. 8.

At 1620, the method may include transmitting a CSI report including the CQI. The operations of 1620 may be performed in accordance with examples as disclosed herein. In some examples, aspects of the operations of 1620 may be performed by a CSI report component 840 as described with reference to FIG. 8.

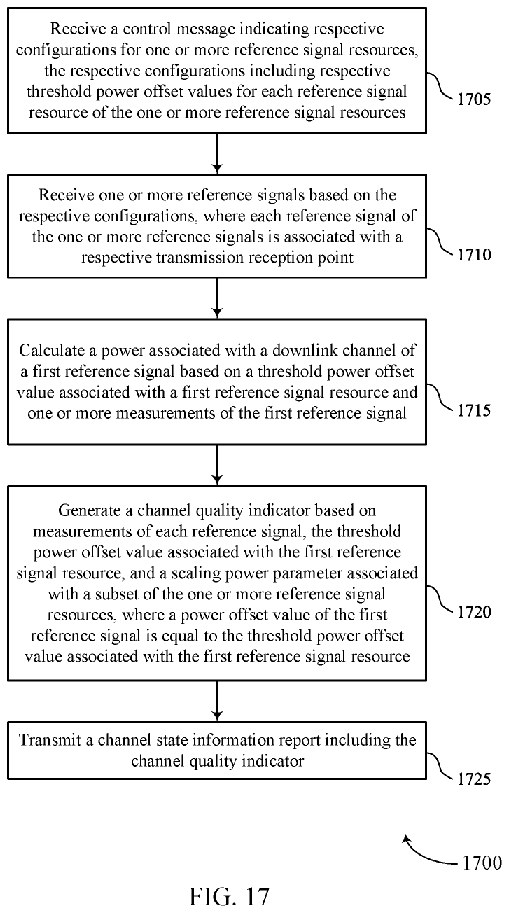

FIG. 17 illustrates a flowchart showing a method 1700 that supports power offset values for CJT mTRP communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating respective configurations for one or more reference signal resources, the respective configurations including respective threshold power offset values for each reference signal resource of the one or more reference signal resources. The operations of 1705 may be performed in accordance with examples as disclosed herein. In some examples, aspects of the operations of 1705 may be performed by a control message component 825 as described with reference to FIG. 8.

At 1710, the method may include receiving one or more reference signals based on the respective configurations, where each reference signal of the one or more reference signals is associated with a respective TRP. The operations of 1710 may be performed in accordance with examples as disclosed herein. In some examples, aspects of the operations of 1710 may be performed by a reference signal component 830 as described with reference to FIG. 8.

At 1715, the method may include calculating a power associated with a downlink shared channel of a first reference signal based on a threshold power offset value associated with a first reference signal resource and one or more measurements of the first reference signal. The operations of 1715 may be performed in accordance with examples as disclosed herein. In some examples, aspects of the operations of 1715 may be performed by a CQI component 835 as described with reference to FIG. 8.

At 1720, the method may include generating a CQI based on measurements of each reference signal, the threshold power offset value associated with the first reference signal resource, and a scaling power parameter associated with a subset of the one or more reference signal resources, where a power offset value of the first reference signal is equal to the threshold power offset value associated with the first reference signal resource. The operations of 1720 may be performed in accordance with examples as disclosed herein. In some examples, aspects of the operations of 1720 may be performed by a CQI component 835 as described with reference to FIG. 8.

At 1725, the method may include transmitting a CSI report including the CQI. The operations of 1725 may be performed in accordance with examples as disclosed herein. In some examples, aspects of the operations of 1725 may be performed by a CSI report component 840 as described with reference to FIG. 8.

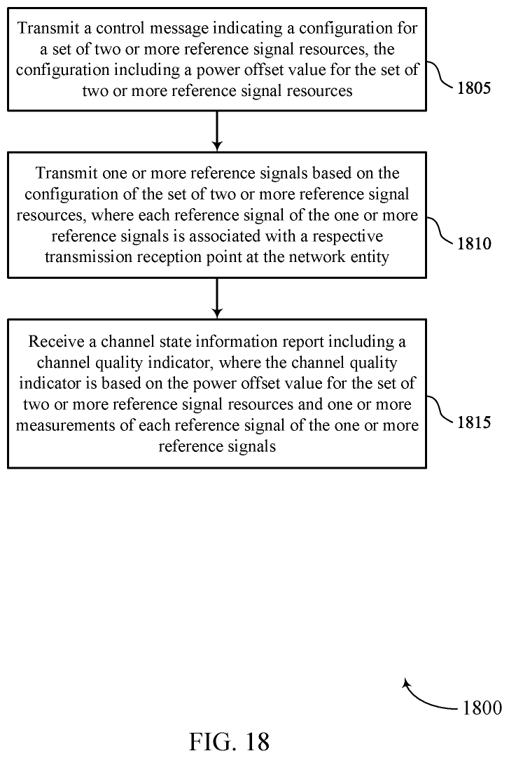

FIG. 18 illustrates a flowchart showing a method 1800 that supports power offset values for CJT mTRP communications in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a control message indicating a configuration for a set of two or more reference signal resources, the configuration including a power offset value for the set of two or more reference signal resources. The operations of 1805 may be performed in accordance with examples as disclosed herein. In some examples, aspects of the operations of 1805 may be performed by a configuration component 1225 as described with reference to FIG. 12.

At 1810, the method may include transmitting one or more reference signals based on the configuration of the set of two or more reference signal resources, where each reference signal of the one or more reference signals is associated with a respective TRP at the network entity. The operations of 1810 may be performed in accordance with examples as disclosed herein. In some examples, aspects of the operations of 1810 may be performed by a reference signal component 1230 as described with reference to FIG. 12.

At 1815, the method may include receiving a CSI report including a CQI, where the CQI is based on the power offset value for the set of two or more reference signal resources and one or more measurements of each reference signal of the one or more reference signals. The operations of 1815 may be performed in accordance with examples as disclosed herein. In some examples, aspects of the operations of 1815 may be performed by a reception component 1235 as described with reference to FIG. 12.

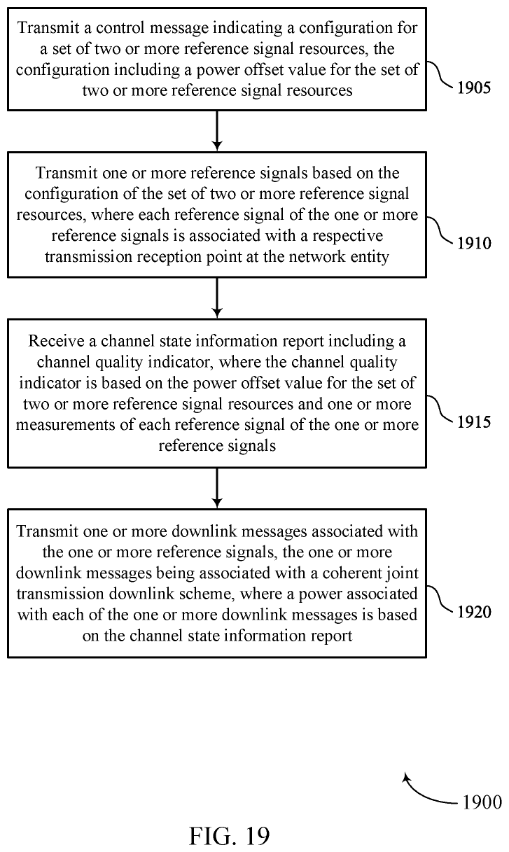

FIG. 19 illustrates a flowchart showing a method 1900 that supports power offset values for CJT mTRP communications in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a control message indicating a configuration for a set of two or more reference signal resources, the configuration including a power offset value for the set of two or more reference signal resources. The operations of 1905 may be performed in accordance with examples as disclosed herein. In some examples, aspects of the operations of 1905 may be performed by a configuration component 1225 as described with reference to FIG. 12.

At 1910, the method may include transmitting one or more reference signals based on the configuration of the set of two or more reference signal resources, where each reference signal of the one or more reference signals is associated with a respective TRP at the network entity. The operations of 1910 may be performed in accordance with examples as disclosed herein. In some examples, aspects of the operations of 1910 may be performed by a reference signal component 1230 as described with reference to FIG. 12.

At 1915, the method may include receiving a CSI report including a CQI, where the CQI is based on the power offset value for the set of two or more reference signal resources and one or more measurements of each reference signal of the one or more reference signals. The operations of 1915 may be performed in accordance with examples as disclosed herein. In some examples, aspects of the operations of 1915 may be performed by a reception component 1235 as described with reference to FIG. 12.

At 1920, the method may include transmitting one or more downlink messages associated with the one or more reference signals, the one or more downlink messages being associated with a CJT downlink scheme, where a power associated with each of the one or more downlink messages is based on the CSI report. The operations of 1920 may be performed in accordance with examples as disclosed herein. In some examples, aspects of the operations of 1920 may be performed by a downlink message component 1240 as described with reference to FIG. 12.

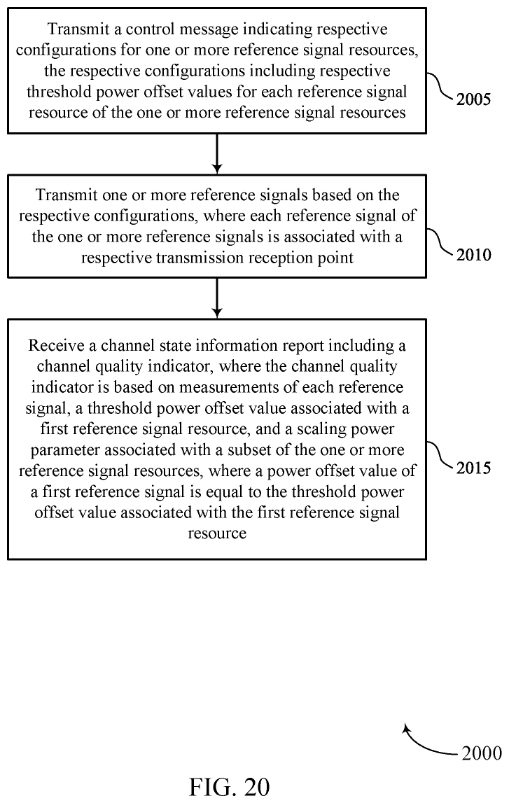

FIG. 20 illustrates a flowchart showing a method 2000 that supports power offset values for CJT mTRP communications in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a control message indicating respective configurations for one or more reference signal resources, the respective configurations including respective threshold power offset values for each reference signal resource of the one or more reference signal resources. The operations of 2005 may be performed in accordance with examples as disclosed herein. In some examples, aspects of the operations of 2005 may be performed by a configuration component 1225 as described with reference to FIG. 12.

At 2010, the method may include transmitting one or more reference signals based on the respective configurations, where each reference signal of the one or more reference signals is associated with a respective TRP. The operations of 2010 may be performed in accordance with examples as disclosed herein. In some examples, aspects of the operations of 2010 may be performed by a reference signal component 1230 as described with reference to FIG. 12.

At 2015, the method may include receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The operations of 2015 may be performed in accordance with examples as disclosed herein. In some examples, aspects of the operations of 2015 may be performed by a reception component 1235 as described with reference to FIG. 12.

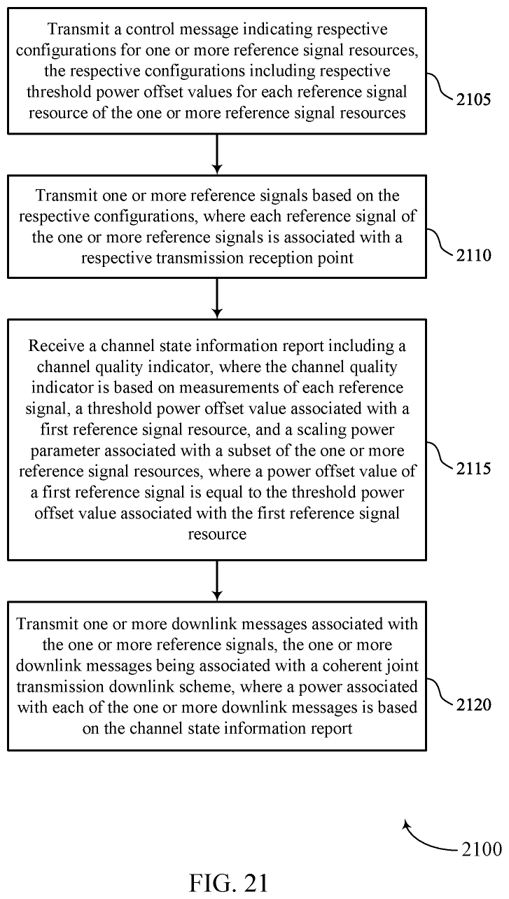

FIG. 21 illustrates a flowchart showing a method 2100 that supports power offset values for CJT mTRP communications in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include transmitting a control message indicating respective configurations for one or more reference signal resources, the respective configurations including respective threshold power offset values for each reference signal resource of the one or more reference signal resources. The operations of 2105 may be performed in accordance with examples as disclosed herein. In some examples, aspects of the operations of 2105 may be performed by a configuration component 1225 as described with reference to FIG. 12.

At 2110, the method may include transmitting one or more reference signals based on the respective configurations, where each reference signal of the one or more reference signals is associated with a respective TRP. The operations of 2110 may be performed in accordance with examples as disclosed herein. In some examples, aspects of the operations of 2110 may be performed by a reference signal component 1230 as described with reference to FIG. 12.

At 2115, the method may include receiving a CSI report including a CQI, where the CQI is based on measurements of each reference signal, a threshold power offset value associated with a first reference signal resource, and a scaling power parameter associated with a subset of the one or more reference signal resources, where a power offset value of a first reference signal is equal to the threshold power offset value associated with the first reference signal resource. The operations of 2115 may be performed in accordance with examples as disclosed herein. In some examples, aspects of the operations of 2115 may be performed by a reception component 1235 as described with reference to FIG. 12.

At 2120, the method may include transmitting one or more downlink messages associated with the one or more reference signals, the one or more downlink messages being associated with a CJT downlink scheme, where a power associated with each of the one or more downlink messages is based on the CSI report. The operations of 2120 may be performed in accordance with examples as disclosed herein. In some examples, aspects of the operations of 2120 may be performed by a downlink message component 1240 as described with reference to FIG. 12.

The following provides an overview of aspects of the present disclosure:
Aspect 1: A method for wireless communication at a UE, comprising: receiving a control message indicating a configuration for a set of two or more reference signal resources, the configuration comprising a power offset value for the set of two or more reference signal resources; receiving one or more reference signals based at least in part on the configuration of the set of two or more reference signal resources, wherein each reference signal of the one or more reference signals is associated with a respective TRP; generating a CQI based at least in part on the power offset value for the set of two or more reference signal resources and one or more measurements of each reference signal of the one or more reference signals; and transmitting a CSI report comprising the CQI.
Aspect 2: The method of aspect 1, wherein generating the CQI further comprises: calculating a power associated with a downlink channel for each reference signal of the one or more reference signals based at least in part on the power offset value for the set of two or more reference signal resources and the one or more measurements, wherein the CQI is based at least in part on the power of the downlink channel for each reference signal of the one or more reference signals.
Aspect 3: The method of aspect 1, wherein generating the CQI further comprises: calculating a power associated with a downlink channel for each reference signal of the one or more reference signals based at least in part on the power offset value for the set of two or more reference signal resources, the one or more measurements, and a scaled power of the set of two or more reference signal resources, wherein the scaled power is based at least in part on a quantity of UE-selected TRPs from a total quantity of TRPs.
Aspect 4: The method of any of aspects 1 through 3, wherein receiving the control message indicating the configuration comprises: receiving the control message indicating a respective power offset value for each reference signal resource of the set of two or more reference signal resources, wherein the power offset value for each reference signal resource of the set of two or more reference signal resources are equal based at least in part on the set of two or more reference signal resources being associated with a CJT by mTRPs.
Aspect 5: The method of any of aspects 1 through 4, wherein each reference signal of the one or more reference signals are transmitted at an equal power based at least in part on the power offset value for the set of two or more reference signal resources.
Aspect 6: The method of any of aspects 1 through 5, wherein the set of two or more reference signal resources comprises a CSI-RS resource set.
Aspect 7: The method of any of aspects 1 through 6, wherein the control message comprises a RRC message.
Aspect 8: A method for wireless communication at a UE, comprising: receiving a control message indicating respective configurations for one or more reference signal resources, the respective configurations comprising respective threshold power offset values for each reference signal resource of the one or more reference signal resources; receiving one or more reference signals based at least in part on the respective configurations, wherein each reference signal of the one or more reference signals is associated with a respective TRP; generating a CQI based at least in part on measurements of each reference signal, a threshold power offset value associated with a first reference signal resource, and a scaling power parameter associated with a subset of the one or more reference signal resources, wherein a power offset value of a first reference signal is equal to the threshold power offset value associated with the first reference signal resource; and transmitting a CSI report comprising the CQI.
Aspect 9: The method of aspect 8, wherein generating the CQI comprises: calculating a power associated with a downlink channel of the first reference signal based at least in part on the threshold power offset value associated with the first reference signal resource and one or more measurements of the first reference signal.
Aspect 10: The method of any of aspects 8 through 9, wherein generating the CQI comprises: calculating a power associated with a downlink channel associated with a second reference signal based at least in part on the power offset value associated with the first reference signal resource, a scaling power parameter associated with the second reference signal, and one or more measurements of the first reference signal and of the second reference signal.
Aspect 11: The method of any of aspects 8 through 10, further comprising: calculating one or more power coefficients of the first reference signal based at least in part on a squared summation of measured amplitudes across the first reference signal; and calculating one or more power coefficients of a second reference signal based at least in part on a squared summation of measured amplitudes across the second reference signal.
Aspect 12: The method of aspect 11, wherein the scaling power parameter is the one or more power coefficients of the second reference signal divided by the one or more power coefficients of the first reference signal.
Aspect 13: The method of any of aspects 8 through 12, further comprising: determining an estimated channel measurement for a channel between the UE and a first TRP associated with the first reference signal, wherein the estimated channel measurement is based at least in part on the threshold power offset value associated with the first reference signal resource; and calculating a PMI based at least in part on the estimated channel measurement.
Aspect 14: The method of any of aspects 8 through 13, further comprising: determining an estimated channel measurement for a channel between the UE and a second TRP different from a first TRP associated with the first reference signal, the second TRP being associated with a reference signal from the subset of the one or more reference signals, wherein the estimated channel measurement is based at least in part on the threshold power offset value associated with the first reference signal resource and the scaling power parameter; and calculating a PMI based at least in part on the estimated channel measurement.
Aspect 15: The method of any of aspects 8 through 14, wherein the one or more reference signal resources comprises CSI-RS resources.
Aspect 16: The method of any of aspects 8 through 15, wherein the control message comprises a RRC message.
Aspect 17: A method for wireless communication at a network entity, comprising: transmitting a control message indicating a configuration for a set of two or more reference signal resources, the configuration comprising a power offset value for the set of two or more reference signal resources; transmitting one or more reference signals based at least in part on the configuration of the set of two or more reference signal resources, wherein each reference signal of the one or more reference signals is associated with a respective TRP at the network entity; and receiving a CSI report comprising a CQI, wherein the CQI is based at least in part on the power offset value for the set of two or more reference signal resources and one or more measurements of each reference signal of the one or more reference signals.
Aspect 18: The method of aspect 17, wherein transmitting the control message indicating the configuration comprises: transmitting the control message indicating a respective power offset value for each reference signal resource of the set of two or more reference signal resources, wherein the power offset value for each reference signal resource of the set of two or more reference signal resources are equal based at least in part on the set of two or more reference signal resources being associated with a CJT by mTRPs.
Aspect 19: The method of any of aspects 17 through 18, wherein each reference signal of the one or more reference signals are transmitted at an equal power based at least in part on the power offset value of the set of two or more reference signal resources.
Aspect 20: The method of any of aspects 17 through 19, further comprising: transmitting one or more downlink messages associated with the one or more reference signals, the one or more downlink messages being associated with a CJT downlink scheme, wherein a power associated with each of the one or more downlink messages is based at least in part on the CSI report.
Aspect 21: The method of any of aspects 17 through 20, wherein the set of two or more reference signal resources comprises a CSI-RS resource set.
Aspect 22: The method of any of aspects 17 through 21, wherein the control message comprises a RRC message.
Aspect 23: A method for wireless communication at a network entity, comprising: transmitting a control message indicating respective configurations for one or more reference signal resources, the respective configurations comprising respective threshold power offset values for each reference signal resource of the one or more reference signal resources; transmitting one or more reference signals based at least in part on the respective configurations, wherein each reference signal of the one or more reference signals is associated with a respective TRP; and receiving a CSI report comprising a CQI, wherein the CQI is based at least in part on measurements of each reference signal, a threshold power offset value associated with a first reference signal resource, and a scaling power parameter associated with a subset of the one or more reference signal resources, wherein a power offset value of a first reference signal is equal to the threshold power offset value associated with the first reference signal resource.
Aspect 24: The method of aspect 23, further comprising: transmitting one or more downlink messages associated with the one or more reference signals, the one or more downlink messages being associated with a CJT downlink scheme, wherein a power associated with each of the one or more downlink messages is based at least in part on the CSI report.
Aspect 25: The method of any of aspects 23 through 24, wherein the one or more reference signal resources comprises a CSI-RS resource set.
Aspect 26: The method of any of aspects 23 through 25, wherein the control message comprises a RRC message.
Aspect 27: An apparatus for wireless communication at a UE, comprising a processor; memory coupled with the processor; and instructions stored in the memory and executable by the processor to cause the apparatus to perform a method of any of aspects 1 through 7.
Aspect 28: An apparatus for wireless communication at a UE, comprising at least one means for performing a method of any of aspects 1 through 7.
Aspect 29: A non-transitory computer-readable medium storing code for wireless communication at a UE, the code comprising instructions executable by a processor to perform a method of any of aspects 1 through 7.
Aspect 30: An apparatus for wireless communication at a UE, comprising a processor; memory coupled with the processor; and instructions stored in the memory and executable by the processor to cause the apparatus to perform a method of any of aspects 8 through 16.
Aspect 31: An apparatus for wireless communication at a UE, comprising at least one means for performing a method of any of aspects 8 through 16.
Aspect 32: A non-transitory computer-readable medium storing code for wireless communication at a UE, the code comprising instructions executable by a processor to perform a method of any of aspects 8 through 16.
Aspect 33: An apparatus for wireless communication at a network entity, comprising a processor; memory coupled with the processor; and instructions stored in the memory and executable by the processor to cause the apparatus to perform a method of any of aspects 17 through 22.
Aspect 34: An apparatus for wireless communication at a network entity, comprising at least one means for performing a method of any of aspects 17 through 22.
Aspect 35: A non-transitory computer-readable medium storing code for wireless communication at a network entity, the code comprising instructions executable by a processor to perform a method of any of aspects 17 through 22.
Aspect 36: An apparatus for wireless communication at a network entity, comprising a processor; memory coupled with the processor; and instructions stored in the memory and executable by the processor to cause the apparatus to perform a method of any of aspects 23 through 26.
Aspect 37: An apparatus for wireless communication at a network entity, comprising at least one means for performing a method of any of aspects 23 through 26.
Aspect 38: A non-transitory computer-readable medium storing code for wireless communication at a network entity, the code comprising instructions executable by a processor to perform a method of any of aspects 23 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive a control message indicating a configuration for a set of two or more reference signal resources, the configuration comprising a power offset value for the set of two or more reference signal resources;
receive one or more reference signals based at least in part on the configuration of the set of two or more reference signal resources, wherein each reference signal of the one or more reference signals is associated with a respective transmission reception point;
generate a channel quality indicator based at least in part on the power offset value for the set of two or more reference signal resources and one or more measurements of each reference signal of the one or more reference signals; and
transmit a channel state information report comprising the channel quality indicator.

2. The apparatus of claim 1, wherein the instructions to generate the channel quality indicator are further executable by the processor to cause the apparatus to:
calculate a power associated with a downlink shared channel for each reference signal of the one or more reference signals based at least in part on the power offset value for the set of two or more reference signal resources and the one or more measurements, wherein the channel quality indicator is based at least in part on the power of the downlink shared channel for each reference signal of the one or more reference signals.

3. The apparatus of claim 1, wherein the instructions to generate the channel quality indicator are further executable by the processor to cause the apparatus to:
calculate a power associated with a downlink shared channel for each reference signal of the one or more reference signals based at least in part on the power offset value for the set of two or more reference signal resources, the one or more measurements, and a scaled power of the set of two or more reference signal resources, wherein the scaled power is based at least in part on a quantity of UE-selected transmission reception points from a total quantity of transmission reception points.

4. The apparatus of claim 1, wherein the instructions to receive the control message indicating the configuration are executable by the processor to cause the apparatus to:
receive the control message indicating a respective power offset value for each reference signal resource of the set of two or more reference signal resources, wherein the power offset value for each reference signal resource of the set of two or more reference signal resources are equal based at least in part on the set of two or more reference signal resources being associated with a coherent joint transmission by multi-transmission reception points.

5. The apparatus of claim 1, wherein each reference signal of the one or more reference signals are transmitted at an equal power based at least in part on the power offset value for the set of two or more reference signal resources.

6. The apparatus of claim 1, wherein the set of two or more reference signal resources comprises a channel state information reference signal resource set.

7. The apparatus of claim 1, wherein the control message comprises a radio resource control message.

8. An apparatus for wireless communication at a user equipment (UE), comprising:
a processor;
memory coupled with the processor; and
instructions stored in the memory and executable by the processor to cause the apparatus to:
receive a control message indicating respective configurations for one or more reference signal resources, the respective configurations comprising respective threshold power offset values for each reference signal resource of the one or more reference signal resources;
receive one or more reference signals based at least in part on the respective configurations, wherein each reference signal of the one or more reference signals is associated with a respective transmission reception point;
generate a channel quality indicator based at least in part on measurements of each reference signal, a threshold power offset value associated with a first reference signal resource, and a scaling power parameter associated with a subset of the one or more reference signal resources, wherein a power offset value of a first reference signal is equal to the threshold power offset value associated with the first reference signal resource; and
transmit a channel state information report comprising the channel quality indicator.

9. The apparatus of claim 8, wherein the instructions to generate the channel quality indicator are executable by the processor to cause the apparatus to:
calculate a power associated with a downlink shared channel of the first reference signal based at least in part on the threshold power offset value associated with the first reference signal resource and one or more measurements of the first reference signal.

10. The apparatus of claim 8, wherein the instructions to generate the channel quality indicator are executable by the processor to cause the apparatus to:
calculate a power associated with a downlink shared channel associated with a second reference signal based at least in part on the threshold power offset value associated with the first reference signal resource, a scaling power parameter associated with the second reference signal, and one or more measurements of the first reference signal and of the second reference signal.

11. The apparatus of claim 8, wherein the instructions are further executable by the processor to cause the apparatus to:
calculate one or more power coefficients of the first reference signal based at least in part on a squared summation of measured amplitudes across the first reference signal; and
calculate one or more power coefficients of a second reference signal based at least in part on a squared summation of measured amplitudes across the second reference signal.

12. The apparatus of claim 11, wherein the scaling power parameter is the one or more power coefficients of the second reference signal divided by the one or more power coefficients of the first reference signal.

13. The apparatus of claim 8, wherein the instructions are further executable by the processor to cause the apparatus to:
determine an estimated channel measurement for a channel between the UE and a first transmission reception point associated with the first reference signal, wherein the estimated channel measurement is based at least in part on the threshold power offset value associated with the first reference signal resource; and
calculate a precoding matrix indicator based at least in part on the estimated channel measurement.

14. The apparatus of claim 8, wherein the instructions are further executable by the processor to cause the apparatus to:
determine an estimated channel measurement for a channel between the UE and a second transmission reception point different from a first transmission reception point associated with the first reference signal, the second transmission reception point being associated with a reference signal from the subset of the one or more reference signals, wherein the estimated channel measurement is based at least in part on the threshold power offset value associated with the first reference signal resource and the scaling power parameter; and
calculate a precoding matrix indicator based at least in part on the estimated channel measurement.

15. The apparatus of claim 8, wherein:
the one or more reference signal resources comprises channel state information reference signal resources.

16. The apparatus of claim 8, wherein the control message comprises a radio resource control message.

17. An apparatus for wireless communication at a network entity, comprising:
a processor;
memory coupled with the processor; and
instructions stored in the memory and executable by the processor to cause the apparatus to:
transmit a control message indicating a configuration for a set of two or more reference signal resources, the configuration comprising a power offset value for the set of two or more reference signal resources;
transmit one or more reference signals based at least in part on the configuration of the set of two or more reference signal resources, wherein each reference signal of the one or more reference signals is associated with a respective transmission reception point at the network entity; and
receive a channel state information report comprising a channel quality indicator, wherein the channel quality indicator is based at least in part on the power offset value for the set of two or more reference signal resources and one or more measurements of each reference signal of the one or more reference signals.

18. The apparatus of claim 17, wherein the instructions to transmit the control message indicating the configuration are executable by the processor to cause the apparatus to:
transmit the control message indicating a respective power offset value for each reference signal resource of the set of two or more reference signal resources, wherein the power offset value for each reference signal resource of the set of two or more reference signal resources are equal based at least in part on the set of two or more reference signal resources being associated with a coherent joint transmission by multi-transmission reception points.

19. The apparatus of claim 17, wherein each reference signal of the one or more reference signals are transmitted at an equal power based at least in part on the power offset value of the set of two or more reference signal resources.

20. The apparatus of claim 17, wherein the instructions are further executable by the processor to cause the apparatus to:
transmit one or more downlink messages associated with the one or more reference signals, the one or more downlink messages being associated with a coherent joint transmission downlink scheme, wherein a power associated with each of the one or more downlink messages is based at least in part on the channel state information report.

21.-30. (canceled)
